(19) United States
(12) Patent Application Publication
(10) Pub. No.: US 2025/0199676 A1
(43) Pub. Date: Jun. 19, 2025

(54) OBJECT-BASED CONTROLS

(71) Applicant: Apple Inc., Cupertino, CA (US)

(72) Inventors: Adam S. MEYER, Cupertino, CA (US); Peter C. TSOI, San Mateo, CA (US)

(21) Appl. No.: 18/643,722

(22) Filed: Apr. 23, 2024

Related U.S. Application Data
(60) Provisional application No. 63/611,070, filed on Dec. 15, 2023.

(51) Int. Cl. G06F 3/0487; G06F 3/01; G06F 3/16

(52) U.S. Cl. CPC G06F 3/0487; G06F 3/011; G06F 3/167

(57) ABSTRACT

The present disclosure generally relates to controlling devices.

### CROSS-REFERENCE TO RELATED APPLICATIONS

The present application claims priority to U.S. Provisional Patent Application Ser. No. 63/611,070 entitled “OBJECT-BASED CONTROLS” filed Dec. 15, 2023, which is hereby incorporated by reference in its entirety for all purposes.

### FIELD

The present disclosure relates generally to computer user interfaces, and more specifically to techniques for interacting with computer systems.

### BACKGROUND

Electronic devices are becoming more common. Such electronic devices can sometimes be controlled by subjects.

### SUMMARY

Some techniques for controlling electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for controlling devices. Such methods and interfaces optionally complement or replace other methods for controlling devices. Such methods and interfaces reduce the cognitive burden on a user and produce a more efficient human-machine interface. For battery-operated computing devices, such methods and interfaces conserve power and increase the time between battery charges.

In some embodiments, a method that is performed at a computer system that is in communication with one or more input devices and one or more output devices is described. In some embodiments, the method comprises: detecting, via the one or more input devices, an input corresponding to a first subject; and in response to detecting the input corresponding to the first subject: in accordance with a determination that a first object, different from the computer system, is with the first subject, outputting, via the one or more output devices, a first attribute of the first object; and in accordance with a determination that the first object is not with the first subject, forgoing outputting, via the one or more output devices, the first attribute of the first object.

In some embodiments, a non-transitory computer-readable storage medium storing one or more programs configured to be executed by one or more processors of a computer system that is in communication with one or more input devices and one or more output devices is described. In some embodiments, the one or more programs includes instructions for: detecting, via the one or more input devices, an input corresponding to a first subject; and in response to detecting the input corresponding to the first subject: in accordance with a determination that a first object, different from the computer system, is with the first subject, outputting, via the one or more output devices, a first attribute of the first object; and in accordance with a determination that the first object is not with the first subject, forgoing outputting, via the one or more output devices, the first attribute of the first object.

In some embodiments, a transitory computer-readable storage medium storing one or more programs configured to be executed by one or more processors of a computer system that is in communication with one or more input devices and one or more output devices is described. In some embodiments, the one or more programs includes instructions for: detecting, via the one or more input devices, an input corresponding to a first subject; and in response to detecting the input corresponding to the first subject: in accordance with a determination that a first object, different from the computer system, is with the first subject, outputting, via the one or more output devices, a first attribute of the first object; and in accordance with a determination that the first object is not with the first subject, forgoing outputting, via the one or more output devices, the first attribute of the first object.

In some embodiments, a computer system that is in communication with one or more input devices and one or more output devices is described. In some embodiments, the computer system that is in communication with one or more input devices and one or more output devices comprises one or more processors and memory storing one or more programs configured to be executed by the one or more processors. In some embodiments, the one or more programs includes instructions for: detecting, via the one or more input devices, an input corresponding to a first subject; and in response to detecting the input corresponding to the first subject: in accordance with a determination that a first object, different from the computer system, is with the first subject, outputting, via the one or more output devices, a first attribute of the first object; and in accordance with a determination that the first object is not with the first subject, forgoing outputting, via the one or more output devices, the first attribute of the first object.

In some embodiments, a computer system that is in communication with one or more input devices and one or more output devices is described. In some embodiments, the computer system that is in communication with one or more input devices and one or more output devices comprises means for performing each of the following steps: detecting, via the one or more input devices, an input corresponding to a first subject; and in response to detecting the input corresponding to the first subject: in accordance with a determination that a first object, different from the computer system, is with the first subject, outputting, via the one or more output devices, a first attribute of the first object; and in accordance with a determination that the first object is not with the first subject, forgoing outputting, via the one or more output devices, the first attribute of the first object.

In some embodiments, a computer program product is described. In some embodiments, the computer program product comprises one or more programs configured to be executed by one or more processors of a computer system that is in communication with one or more input devices and one or more output devices. In some embodiments, the one or more programs include instructions for: detecting, via the one or more input devices, an input corresponding to a first subject; and in response to detecting the input corresponding to the first subject: in accordance with a determination that a first object, different from the computer system, is with the first subject, outputting, via the one or more output devices, a first attribute of the first object; and in accordance with a determination that the first object is not with the first subject, forgoing outputting, via the one or more output devices, the first attribute of the first object.

In some embodiments, a method that is performed at a computer system that is in communication with one or more input devices is described. In some embodiments, the method comprises: detecting, via the one or more input devices, a first input directed to a first object associated with a device; while detecting the first input directed to the first object, detecting, via the one or more input devices, a second input different from the first input; and in response to detecting the second input: in accordance with a determination that a user account includes a first set of data and that the second input is a first type, causing the device to perform a first operation; in accordance with a determination that the user account includes a second set of data different from the first set of data and that the second input is the first type, forgoing causing the device to perform the first operation; and in accordance with a determination that the user account includes the second set of data and that the second input is a second type different from the first type, causing the device to perform the first operation.

In some embodiments, a non-transitory computer-readable storage medium storing one or more programs configured to be executed by one or more processors of a computer system that is in communication with one or more input devices is described. In some embodiments, the one or more programs includes instructions for: detecting, via the one or more input devices, a first input directed to a first object associated with a device; while detecting the first input directed to the first object, detecting, via the one or more input devices, a second input different from the first input; and in response to detecting the second input: in accordance with a determination that a user account includes a first set of data and that the second input is a first type, causing the device to perform a first operation; in accordance with a determination that the user account includes a second set of data different from the first set of data and that the second input is the first type, forgoing causing the device to perform the first operation; and in accordance with a determination that the user account includes the second set of data and that the second input is a second type different from the first type, causing the device to perform the first operation.

In some embodiments, a transitory computer-readable storage medium storing one or more programs configured to be executed by one or more processors of a computer system that is in communication with one or more input devices is described. In some embodiments, the one or more programs includes instructions for: detecting, via the one or more input devices, a first input directed to a first object associated with a device; while detecting the first input directed to the first object, detecting, via the one or more input devices, a second input different from the first input; and in response to detecting the second input: in accordance with a determination that a user account includes a first set of data and that the second input is a first type, causing the device to perform a first operation; in accordance with a determination that the user account includes a second set of data different from the first set of data and that the second input is the first type, forgoing causing the device to perform the first operation; and in accordance with a determination that the user account includes the second set of data and that the second input is a second type different from the first type, causing the device to perform the first operation.

In some embodiments, a computer system that is in communication with one or more input devices is described. In some embodiments, the computer system that is in communication with one or more input devices comprises one or more processors and memory storing one or more programs configured to be executed by the one or more processors. In some embodiments, the one or more programs includes instructions for: detecting, via the one or more input devices, a first input directed to a first object associated with a device; while detecting the first input directed to the first object, detecting, via the one or more input devices, a second input different from the first input; and in response to detecting the second input: in accordance with a determination that a user account includes a first set of data and that the second input is a first type, causing the device to perform a first operation; in accordance with a determination that the user account includes a second set of data different from the first set of data and that the second input is the first type, forgoing causing the device to perform the first operation; and in accordance with a determination that the user account includes the second set of data and that the second input is a second type different from the first type, causing the device to perform the first operation.

In some embodiments, a computer system that is in communication with one or more input devices is described. In some embodiments, the computer system that is in communication with one or more input devices comprises means for performing each of the following steps: detecting, via the one or more input devices, a first input directed to a first object associated with a device; while detecting the first input directed to the first object, detecting, via the one or more input devices, a second input different from the first input; and in response to detecting the second input: in accordance with a determination that a user account includes a first set of data and that the second input is a first type, causing the device to perform a first operation; in accordance with a determination that the user account includes a second set of data different from the first set of data and that the second input is the first type, forgoing causing the device to perform the first operation; and in accordance with a determination that the user account includes the second set of data and that the second input is a second type different from the first type, causing the device to perform the first operation.

In some embodiments, a computer program product is described. In some embodiments, the computer program product comprises one or more programs configured to be executed by one or more processors of a computer system that is in communication with one or more input devices. In some embodiments, the one or more programs include instructions for: detecting, via the one or more input devices, a first input directed to a first object associated with a device; while detecting the first input directed to the first object, detecting, via the one or more input devices, a second input different from the first input; and in response to detecting the second input: in accordance with a determination that a user account includes a first set of data and that the second input is a first type, causing the device to perform a first operation; in accordance with a determination that the user account includes a second set of data different from the first set of data and that the second input is the first type, forgoing causing the device to perform the first operation; and in accordance with a determination that the user account includes the second set of data and that the second input is a second type different from the first type, causing the device to perform the first operation.

In some embodiments, a method that is performed at a computer system that is in communication with one or more input devices and one or more output devices is described. In some embodiments, the method comprises: detecting, via the one or more input devices, an input corresponding to a request to perform an operation; and in response to detecting the input corresponding to the request to perform the operation: in accordance with a determination that attention of a first subject is directed to a first object different from the computer system and a first device different from the computer system, causing the first device to perform a first operation; and in accordance with a determination that the attention of the first subject is not directed to the first object, forgoing causing the first device to perform the first operation.

In some embodiments, a non-transitory computer-readable storage medium storing one or more programs configured to be executed by one or more processors of a computer system that is in communication with one or more input devices and one or more output devices is described. In some embodiments, the one or more programs includes instructions for: detecting, via the one or more input devices, an input corresponding to a request to perform an operation; and in response to detecting the input corresponding to the request to perform the operation: in accordance with a determination that attention of a first subject is directed to a first object different from the computer system and a first device different from the computer system, causing the first device to perform a first operation; and in accordance with a determination that the attention of the first subject is not directed to the first object, forgoing causing the first device to perform the first operation.

In some embodiments, a transitory computer-readable storage medium storing one or more programs configured to be executed by one or more processors of a computer system that is in communication with one or more input devices and one or more output devices is described. In some embodiments, the one or more programs includes instructions for: detecting, via the one or more input devices, an input corresponding to a request to perform an operation; and in response to detecting the input corresponding to the request to perform the operation: in accordance with a determination that attention of a first subject is directed to a first object different from the computer system and a first device different from the computer system, causing the first device to perform a first operation; and in accordance with a determination that the attention of the first subject is not directed to the first object, forgoing causing the first device to perform the first operation.

In some embodiments, a computer system that is in communication with one or more input devices and one or more output devices is described. In some embodiments, the computer system that is in communication with one or more input devices and one or more output devices comprises one or more processors and memory storing one or more programs configured to be executed by the one or more processors. In some embodiments, the one or more programs includes instructions for: detecting, via the one or more input devices, an input corresponding to a request to perform an operation; and in response to detecting the input corresponding to the request to perform the operation: in accordance with a determination that attention of a first subject is directed to a first object different from the computer system and a first device different from the computer system, causing the first device to perform a first operation; and in accordance with a determination that the attention of the first subject is not directed to the first object, forgoing causing the first device to perform the first operation.

In some embodiments, a computer system that is in communication with one or more input devices and one or more output devices is described. In some embodiments, the computer system that is in communication with one or more input devices and one or more output devices comprises means for performing each of the following steps: detecting, via the one or more input devices, an input corresponding to a request to perform an operation; and in response to detecting the input corresponding to the request to perform the operation: in accordance with a determination that attention of a first subject is directed to a first object different from the computer system and a first device different from the computer system, causing the first device to perform a first operation; and in accordance with a determination that the attention of the first subject is not directed to the first object, forgoing causing the first device to perform the first operation.

In some embodiments, a computer program product is described. In some embodiments, the computer program product comprises one or more programs configured to be executed by one or more processors of a computer system that is in communication with one or more input devices and one or more output devices. In some embodiments, the one or more programs include instructions for: detecting, via the one or more input devices, an input corresponding to a request to perform an operation; and in response to detecting the input corresponding to the request to perform the operation: in accordance with a determination that attention of a first subject is directed to a first object different from the computer system and a first device different from the computer system, causing the first device to perform a first operation; and in accordance with a determination that the attention of the first subject is not directed to the first object, forgoing causing the first device to perform the first operation.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for controlling devices, thereby increasing the effectiveness, efficiency, and user satisfaction with such devices. Such methods and interfaces may complement or replace other methods for controlling devices.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating an electronic device in accordance with some embodiments.

FIGS. 2A-2B illustrate techniques for responding to requests in accordance with some embodiments.

FIG. 3 is a flow diagram illustrating a method for responding to requests in accordance with some embodiments.

FIGS. 4A-4D illustrate techniques for controlling computer systems in accordance with some embodiments.

FIG. 5 is a flow diagram illustrating a method for controlling computer systems in accordance with some embodiments.

FIG. 6 is a flow diagram illustrating a method for controlling computer systems in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary examples.

There is a need for electronic devices that provide efficient methods and interfaces for controlling devices using gestures. For example, an air gesture can cause different operations to be performed depending on which subject performs the air gesture. For another example, the same air gesture can be used in different modes to either transition modes and/or change content being output. For another example, different types of moving air gestures can cause different operations to be performed. Such techniques can reduce the cognitive burden on a user using an electronic device, thereby enhancing productivity. Further, such techniques can reduce processor and battery power otherwise wasted on redundant user inputs.

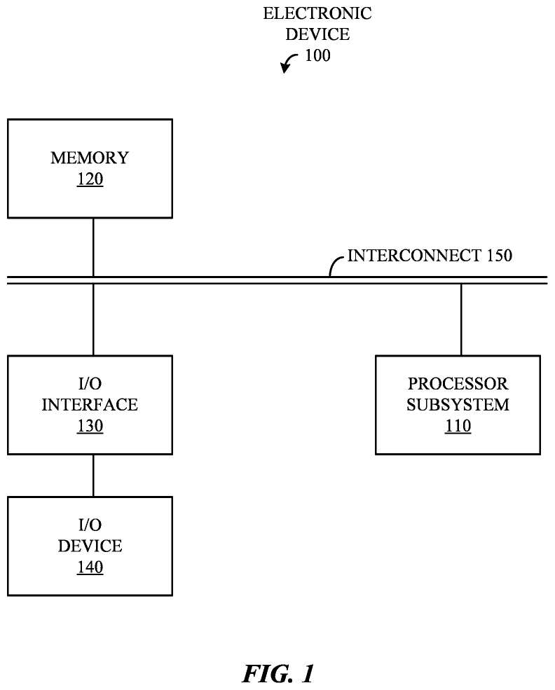

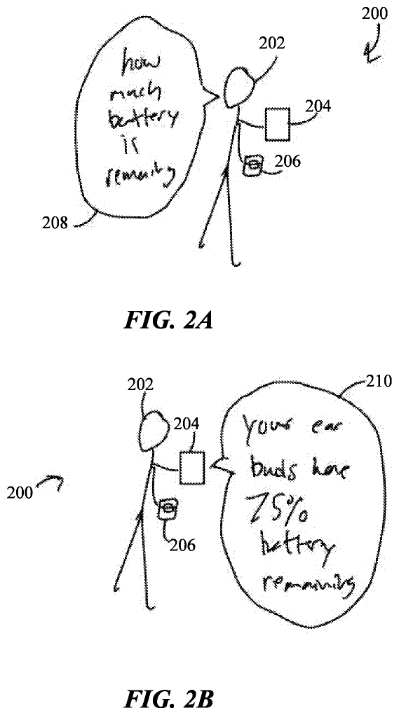

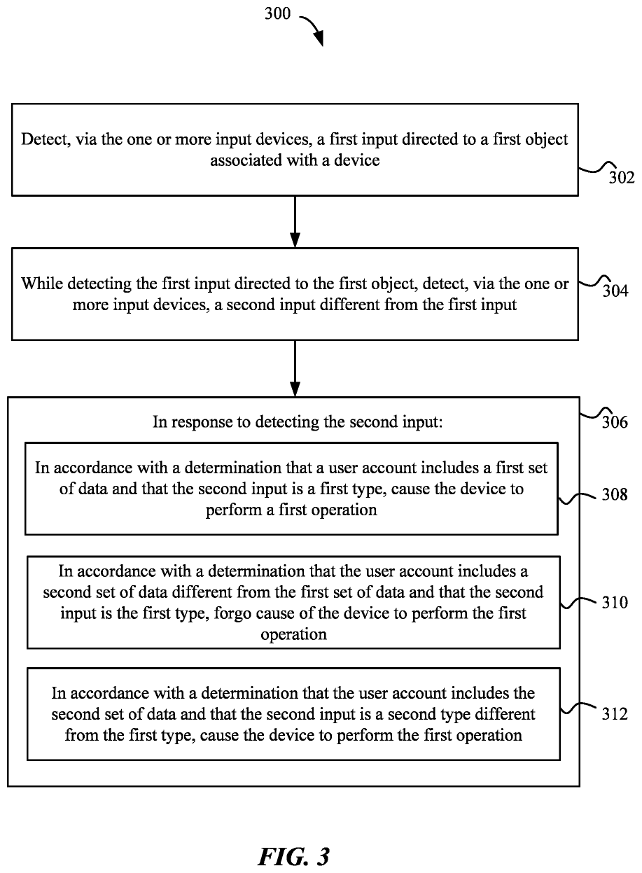

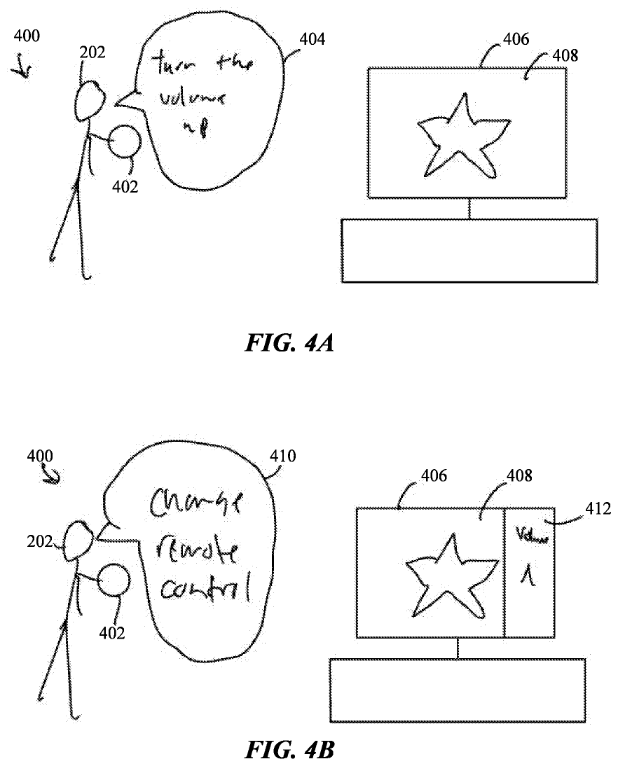

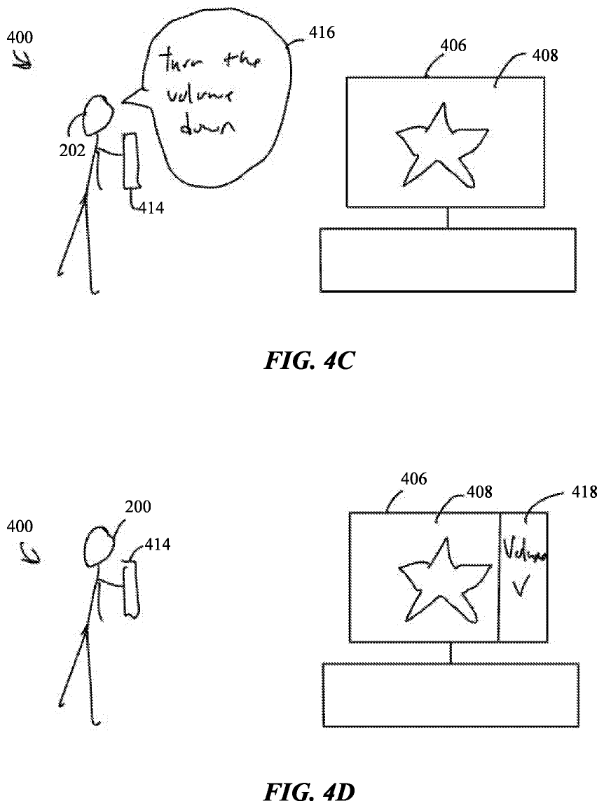

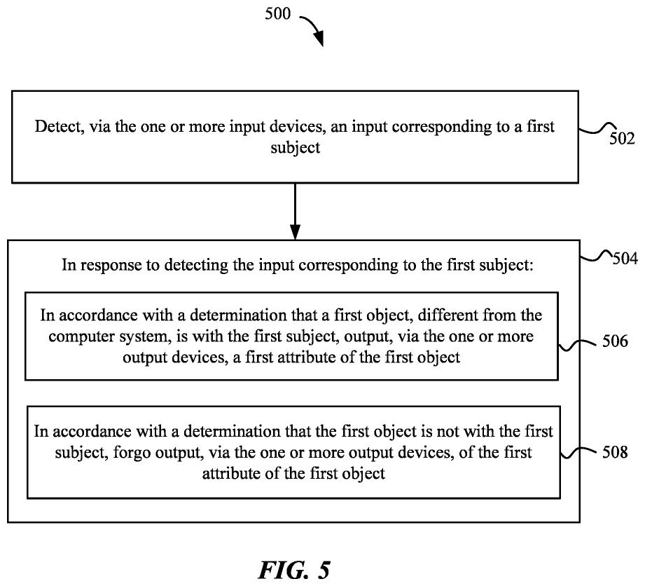

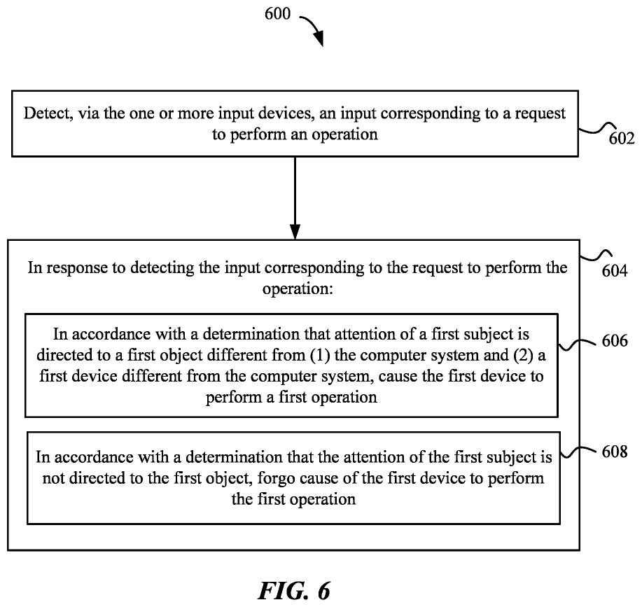

Below, FIG. 1 provides a description of an exemplary device for performing the techniques for controlling devices. FIGS. 2A-2B illustrate techniques for responding to requests in accordance with some embodiments. FIG. 3 is a flow diagram illustrating a method for responding to requests in accordance with some embodiments. The user interfaces in FIGS. 2A-2B are used to illustrate the processes described below, including the processes in FIG. 3. FIGS. 4A-4D illustrate techniques for controlling computer systems in accordance with some embodiments. FIG. 5 is a flow diagram illustrating a method for controlling computer systems in accordance with some embodiments. FIG. 6 is a flow diagram illustrating a method for controlling computer systems in accordance with some embodiments. The user interfaces in FIGS. 4A-4D are used to illustrate the processes described below, including the processes in FIGS. 5-6.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

Methods described herein can include one or more steps that are contingent upon one or more conditions being satisfied. It should be understood that a method can occur over multiple iterations of the same process with different steps of the method being satisfied in different iterations. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied. Thus, a method described with steps that are contingent upon a condition being satisfied can be rewritten as a method that is repeated until each of the conditions described in the method are satisfied. This, however, is not required of electronic device, system, or computer readable medium claims where the electronic device, system, or computer readable medium claims include instructions for performing one or more steps that are contingent upon one or more conditions being satisfied. Because the instructions for the electronic device, system, or computer readable medium claims are stored in one or more processors and/or at one or more memory locations, the electronic device, system, or computer readable medium claims include logic that can determine whether the one or more conditions have been satisfied without explicitly repeating steps of a method until all of the conditions upon which steps in the method are contingent have been satisfied. A person having ordinary skill in the art would also understand that, similar to a method with contingent steps, an electronic system, system, or computer readable storage medium can repeat the steps of a method as many times as needed to ensure that all of the contingent steps have been performed.

Although the following description uses terms “first,” “second,” etc. to describe various elements, these elements should not be limited by the terms. In some embodiments, these terms are used to distinguish one element from another. For example, a first device could be termed a second device, and, similarly, a second device or a device could be termed a first device, without departing from the scope of the various described examples. In some embodiments, the first device and the second device are two separate references to the same device. In some embodiments, the first device and the second device are both devices, but they are not the same device or the same type of device.

The terminology used in the description of the various described examples herein is for the purpose of describing particular examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

Turning to FIG. 1, a block diagram of electronic device 100 is illustrated. Electronic device 100 is a non-limiting example of an electronic device that can be used to perform functionality described herein. It should be recognized that other computer architectures of an electronic device can be used to perform functionality described herein.

In the illustrated example, electronic device 100 includes processor subsystem 110 communicating with memory 120 (e.g., a system memory) and I/O interface 130 via interconnect 150 (e.g., a system bus, one or more memory locations, or other communication channel for connecting multiple components of electronic device 100). In addition, I/O interface 130 is communicating with (e.g., wired or wirelessly) I/O device 140. In some embodiments, I/O interface 130 is included with I/O device 140 such that the two are a single component. It should be recognized that there can be one or more I/O interfaces, with each I/O interface communicating with one or more I/O devices. In some embodiments, multiple instances of processor subsystem 110 can be communicating via interconnect 150.

Electronic device 100 can be any of various types of devices, including, but not limited to, a system on a chip, a server system, a personal electronic device, a smart phone, a smart watch, a wearable device, a tablet, a laptop computer, a fitness tracking device, a head-mounted display (HMD) device, a desktop computer, an accessory (e.g., switch, light, speaker, air conditioner, heater, window cover, fan, lock, media playback device, television, and so forth), a controller, a hub, and/or a sensor. In some embodiments, a sensor includes one or more hardware components that detect information about a physical environment in proximity of (e.g., surrounding) the sensor. In some embodiments, a hardware component of a sensor includes a sensing component (e.g., an image sensor or temperature sensor), a transmitting component (e.g., a laser or radio transmitter), and/or a receiving component (e.g., a laser or radio receiver). Examples of sensors include an angle sensor, a breakage sensor such as a glass breakage sensor, a chemical sensor, a contact sensor, a non-contact sensor, a flow sensor, a force sensor, a gas sensor, a humidity or moisture sensor, an image sensor (e.g., a RGB camera and/or an infrared sensor), an inertial measurement unit, a leak sensor, a level sensor, a metal sensor, a microphone, a motion sensor, a particle sensor, a photoelectric sensor (e.g., ambient light and/or solar), a position sensor (e.g., a global positioning system), a precipitation sensor, a pressure sensor, a proximity sensor, a radiation sensor, a range or depth sensor (e.g., RADAR, LiDAR), a speed sensor, a temperature sensor, a time-of-flight sensor, a torque sensor, and an ultrasonic sensor, a vacancy sensor, an voltage and/or current sensor, and/or a water sensor. In some embodiments, sensor data is captured by fusing data from one sensor with data from one or more other sensors. Although a single electronic device is shown in FIG. 1, electronic device 100 can also be implemented as two or more electronic devices operating together.

In some embodiments, processor subsystem 110 includes one or more processors or processing units configured to execute program instructions to perform functionality described herein. For example, processor subsystem 110 can execute an operating system and/or one or more applications.

Memory 120 can include a computer readable medium (e.g., non-transitory or transitory computer readable medium) usable to store (e.g., configured to store, assigned to store, and/or that stores) program instructions executable by processor subsystem 110 to cause electronic device 100 to perform various operations described herein. For example, memory 120 can store program instructions to implement the functionality associated with method 300 described below.

Memory 120 can be implemented using different physical, non-transitory memory media, such as hard disk storage, optical drive storage, floppy disk storage, removable disk storage, removable flash drive, storage array, a storage area network (e.g., SAN), flash memory, random access memory (e.g., RAM-SRAM, EDO RAM, SDRAM, DDR SDRAM, and/or RAMBUS RAM), and/or read only memory (e.g., PROM and/or EEPROM).

I/O interface 130 can be any of various types of interfaces configured to communicate with other devices. In some embodiments, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (e.g., as described above with respect to memory 120), network interface devices (e.g., to a local or wide-area network), sensor devices (e.g., as described above with respect to sensors), a physical user-interface device (e.g., a physical keyboard, a mouse, and/or a joystick), and an auditory and/or visual output device (e.g., speaker, light, screen, and/or projector). In some embodiments, the visual output device is referred to as a display generation component. The display generation component is configured to provide visual output, such as display via an LED display or image projection. As used herein, “displaying” content includes causing to display the content (e.g., video data rendered or decoded by a display controller) by transmitting, via a wired or wireless connection, data (e.g., image data or video data) to an integrated or external display generation component to visually produce the content.

In some embodiments, I/O device 140 includes one or more camera sensors (e.g., one or more optical sensors and/or one or more depth camera sensors), such as for recognizing a subject and/or a subject's gestures (e.g., hand gestures and/or air gestures) as input. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, I/O device 140 is integrated with other components of electronic device 100. In some embodiments, I/O device 140 is separate from other components of electronic device 100. In some embodiments, I/O device 140 includes a network interface device that permits electronic device 100 to communicate with a network or other electronic devices, in a wired or wireless manner. Exemplary network interface devices include Wi-Fi, Bluetooth, NFC, USB, Thunderbolt, Ethernet, Thread, UWB, and so forth.

In some embodiments, I/O device 140 include one or more camera sensors (e.g., one or more optical sensors and/or one or more depth camera sensors), such as for tracking a user's gestures (e.g., hand gestures and/or air gestures) as input. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

Attention is now directed towards embodiments of user interfaces (“UI”) and associated processes that are implemented on an electronic device, such as electronic device 100.

FIGS. 2A-2B illustrate techniques for responding to requests in accordance with some embodiments. The user interfaces in these figures are used to illustrate the processes described below, including the processes in FIG. 3.

FIGS. 2A-2B illustrate first computer system 204 responding to an ambiguous verbal request of subject 202 in environment 200. In some embodiments, first computer system 204 is a smart phone that includes one or more components and/or features described above in relation to electronic device 100. It should be recognized that first computer system 204 can be other types of electronic devices, including an ear bud, an ear bud case, a headphone, a smart watch, a smart display, a smart speaker, a tablet, a television, a laptop, a fitness tracking device, and/or a head-mounted display device.

As illustrated in FIG. 2A, subject 202 is holding second computer system 206. In some embodiments, second computer system 206 is an ear bud case that includes one or more components and/or features described above in relation to electronic device 100. It should be recognized that second computer system 206 can be other types of electronic devices, including an ear bud, a headphone, a smart phone, a smart watch, a smart display, a smart speaker, a tablet, a television, a laptop, a fitness tracking device, and/or a head-mounted display device.

In the discussion below, the first computer system 204 detects an attention of subject 202 in conjunction with a verbal request by subject 202 and, in response, performs an operation. However, it should be recognized that one or more other computer systems can detect sensor data (e.g., an image and/or a verbal request), communicate the sensor data, detect an attention of subject 202 using the sensor data, communicate an identification of the attention, determine an operation to perform in response to the sensor data, and/or cause first computer system 204 to perform the operation. For example, an ecosystem can include a camera for capturing media (e.g., one or more images and/or a video) of an environment, a controller device (e.g., as described further below) for (1) detecting a verbal request and/or the attention of subject 202 and (2) causing first computer system 204 to perform an operation based on detecting the verbal request. For another example, a subject can be wearing a head-mounted display device that includes a camera for capturing an attention of the subject. The head-mounted display device can receive content (e.g., one or more images and/or a video) from the camera, identify the attention of the subject in the content, and cause computer system 200 to perform an operation based on a verbal request. For another example, a subject can be wearing a smart watch that includes a gyroscope for capturing movements of the subject. The smart watch can receive sensor data from the gyroscope, identify an attention of the subject using the sensor data, send an identification of the attention to another computer system (e.g., a smart phone) so that the smart phone can cause computer system 200 to perform different operations based on the attention.

As illustrated in FIG. 2A, subject 202 verbally asks request 208 (e.g., “how much battery is remaining?”). Notably, request 208 does not refer to which computer system that subject 202 is asking about. Instead, request 208 is generic in that request 208 could correspond to any of many computer systems, including first computer system 204, second computer system 206, and/or another computer system different from first computer system 204 and second computer system 206. In some embodiments, request 208 is directed to first computer system 204, such as based on subject 202 causing first computer system 204 to listen for request 208 via a press of a physical button, a tap of a user-interface element, and/or a verbal input including a keyword. In other embodiments, request 208 is not directed to first computer system 204 but rather first computer system 204 determines and/or is selected to respond to request 208. It should be recognized that verbally asking request 208 is just one form of input and that other types of input can be used with techniques described herein, including an input detected via a touch-sensitive surface, a physical input mechanism (e.g., a physical button and/or slider), and/or a camera (e.g., an air gesture). At FIG. 2A, first computer system 204 detects (e.g., via a microphone of and/or in communication with first computer system 204) request 208.

As illustrated in FIG. 2B, in response to detecting request 208, first computer system 204 acoustically outputs response 210 (e.g., “your ear buds have 75% battery remaining”). Accordingly, response 210 includes an amount of battery remaining for ear buds of subject 202 (sometimes referred to as an attribute of second computer system 206). It should be recognized that acoustically outputting response 210 is just one example of how first computer system 204 can output response 210 and that other ways to output response 210 in addition to and/or instead of acoustically outputting are within the scope of this disclosure, including displaying, via a display generation component of and/or in communication with first computer system 204, a representation and/or an indication of response 210.

Notably, FIG. 2B illustrates that response 210 corresponds to second computer system 206 even though request 208 did not include an indication of second computer system 206. In some embodiments, first computer system 204 detects an attention of subject 202 to determine to which computer system the request 208 corresponds. For explanatory purposes, the attention of subject 202 can be determined to correspond to (1) a computer system that is being held by, looked at, touched by, pointed at, and/or within a predefined distance from subject 202 (e.g., as detected in an image of environment 200 and/or signal strength between first computer system 204 and second computer system 206) and/or (2) a computer system that is paired and/or in communication with first computer system 204.

In some embodiments, different forms of attention can take precedent over other forms of attention depending on a current context (e.g., a state of environment 200, a state of subject 202, content of request 208, and/or a state of a computer system, such as first computer system 204 and/or second computer system 206). For example, if subject 202 is holding second computer system 206 and is directing their gaze to content playing on a tablet (e.g., without holding the tablet), request 202 can be determined to correspond to second computer system 206 as a result of subject 202 holding second computer system 206. For another example, with the same situation as the previous example, request 202 can be determined to correspond to second computer system 206 as a result of subject 202 directing their gaze to the tablet. Such examples illustrate that different configurations and/or precedents can cause different results in the same situation. It should be recognized that other ways to detect the attention of subject 202 can be used with techniques described herein.

In some embodiments, response 210 includes a visual attribute of second computer system 206, such that the visual attribute is obtained by first computer system 204 without communicating with second computer system 206 (e.g., via an image of second computer system 206). In some embodiments, response 210 includes a non-visual attribute of second computer system 206 (e.g., an attribute stored by second computer system 206), such that the non-visual attribute is obtained by first computer system 204 by communicating with second computer system 206.

In some embodiments, second computer system 206 is not in communication with first computer system 204 before and/or while request 208 is detected. In some embodiments, first computer system 204 connects with and/or initiates communication with second computer system 206 in response to detecting request 208. Such communication can be used to identify information to include in response 210, such as an amount of battery remaining in second computer system 206. In some embodiments, first computer system 204 receives information included in response 210 before detecting request 208 (e.g., within a predefined period of time within) and, as a result, does not connect and/or communicate with second computer system 206 to respond to request 208.

In some embodiments, another request by subject 202 (e.g., including a request with the same content as and/or different content than request 208) is determined to correspond to another attribute of second computer system 206 (e.g., an attribute other than an amount of battery remaining for second computer system 206) or another computer system. For example, the other request can include an indication of and/or relate to a different attribute, causing a response to the other request to correspond to the different attribute. For another example, the other request can include an indication of and/or relate to an attribute that second computer system 206 does not have, causing a response to the other response to correspond to a computer system with the attribute corresponding to the other request. For another example, first computer system 204 can detect that the attention of subject 202 is on another computer system (e.g., first computer system 204 and/or another computer system from first computer system 204) different from second computer system 206. Accordingly, first computer system 204 can output a response with respect to the other computer system instead of second computer system 206. For another example, first computer system 204 can detect that the attention of subject 202 is not on another computer system. Accordingly, first computer system 204 can output a response with respect to first computer system 204 instead of another computer system.

While the description above relates to a physical environment, it should be recognized that similar aspects can be used in a virtual environment, such as detecting an attention of a subject within the virtual environment and responding to requests by the subject based on the attention of the subject within the virtual environment.

FIG. 3 is a flow diagram illustrating a method (e.g., method 300) for responding to requests in accordance with some embodiments. Some operations in method 300 are, optionally, combined, the orders of some operations are, optionally, changed, and some operations are, optionally, omitted.

As described below, method 300 provides an intuitive way for responding to requests. Method 300 reduces the cognitive burden on a user for interacting with a computer system, thereby creating a more efficient human-machine interface. For battery-operated computing devices, enabling a user to interact with a computer system faster and more efficiently conserves power and increases the time between battery charges.

In some embodiments, method 300 is performed at a computer system (e.g., 204 and/or the controller device as described herein) that is in communication with one or more input devices (e.g., a camera, a depth sensor, and/or a microphone) and one or more output devices (e.g., a speaker, a haptic output device, a display screen, a projector, and/or a touch-sensitive display). In some embodiments, the computer system is an accessory, a controller, a fitness tracking device, a watch, a phone, a tablet, a processor, a head-mounted display (HMD) device, and/or a personal computing device.

The computer system detects (302), via the one or more input devices, an input (e.g., a tap input and/or a non-tap input (e.g., a voice command or request, a swipe input, a hold-and-drag input, a gaze input, an air gesture, and/or a mouse click)) (e.g., 208) corresponding to (e.g., associated with, of, and/or performed by) a first subject (e.g., a person, a user, an animal, an object, and/or a device) (e.g., 202).

In response to (304) detecting the input corresponding to the first subject, in accordance with a determination that a first object (e.g., a physical object, a virtual object, a remote control, a non-electrical object, and/or an electrical object) (e.g., 206), different from the computer system, is with (e.g., within a predefined and/or threshold distance of, being held by, in the possession of, and/or the attention of) the first subject (e.g., not based on signal strength), the computer system outputs (306) (e.g., 210), via the one or more output devices, a first attribute (e.g., a characteristic, a setting, a state, a mode, and/or data stored by the first object) (e.g., “75%” in FIG. 2B) of the first object. In some embodiments, the input corresponding to the first subject does not include an identification of the first object.

In response to (304) detecting the input corresponding to the first subject, in accordance with a determination that the first object is not with the first subject, the computer system forgoes (308) output of, via the one or more output devices, the first attribute of the first object. In some embodiments, the computer system detects the first object with the first subject. In some embodiments, in response to detecting the first object with the first subject, the computer system detects the input corresponding to the first subject. In some embodiments, in response to detecting the input corresponding to the first subject, the computer system outputs the first attribute of the first object. Outputting the first attribute of the first object when the first object is with the first subject and not when the first object is not with the first subject allows the computer system to selectively output the first attribute of the first object based on whether the first subject has indicated attention to the first object (e.g., that the first object is with the first subject), thereby reducing the number of inputs needed to perform an operation, providing additional control options without cluttering the user interface with additional displayed controls, and/or performing an operation when a set of conditions has been met without requiring further user input.

In some embodiments, the first object is not in communication with the computer system while (and/or when, before, and/or after) detecting the input corresponding to the first subject. In some embodiments, in response to detecting the input corresponding to the first subject, the computer system establishes a connection with the first device. In some embodiments, the first device is in communication with the computer system before, while, and/or after outputting the first attribute of the first object. In some embodiments, the computer system identifies the first object through and/or via one or more cameras (e.g., via identifying the first object in one or more images captured by the one or more cameras). The first object not being in communication with the computer system when detecting the input corresponding to the first subject allows a user to obtain information from objects that are not already in communication with the computer system by the objects being with the first subject, thereby reducing the number of inputs needed to perform an operation, performing an operation when a set of conditions has been met without requiring further user input, and/or increasing security.

In some embodiments, the first object is in communication with the computer system (e.g., when, before, while, and/or after detecting the input corresponding to the first subject). In some embodiments, the first object is paired with the computer system (e.g., when, before, while, and/or after detecting the input corresponding to the first subject). The first object being in communication with the computer system allows the computer system to obtain information corresponding to the first attribute from the first object via a communication so that such information can be output by the computer system, thereby reducing the number of inputs needed to perform an operation and/or performing an operation when a set of conditions has been met without requiring further user input.

In some embodiments, the first object is a physical object (e.g., in a physical environment) (e.g., an object that does not require an electronic device to be present and/or visible). In some embodiments, the first object is a tangible object (or device). In some embodiments, the first object includes at least one hardware and/or electrical component. The first object being a physical object allows (1) the computer system to locate the first object via a camera and/or other sensor sensing data from a physical environment and/or (2) the first subject to obtain information related to objects in the physical environment (e.g., in an intuitive way), thereby reducing the number of inputs needed to perform an operation and/or performing an operation when a set of conditions has been met without requiring further user input.

In some embodiments, the first object is a virtual object. In some embodiments, the first object (or device) is rendered (or displayed) via the one or more output devices. In some embodiments, the first object does not include a hardware and/or electrical component. In some embodiments, the first object is a software program and/or an output of the software program. The first object being a virtual object allows the first subject to obtain information related to objects in their proximity by having the objects with the first subject, thereby reducing the number of inputs needed to perform an operation and/or performing an operation when a set of conditions has been met without requiring further user input.

In some embodiments, the one or more output devices includes a display generation component (e.g., a display screen, a projector, and/or a touch-sensitive display). In some embodiments, outputting the first attribute of the first device includes displaying, via the display generation component, an indication (and/or a representation) (e.g., text, an image, and/or a diagram concerning, corresponding to, related to, and/or associated with the first attribute) of the first attribute of the first device. Outputting the first attribute of the first device including displaying an indication of the first attribute of the first object allows the computer system to visually indicate a state known by the computer system that is not necessarily visible otherwise, thereby providing improved visual feedback to the user and/or performing an operation when a set of conditions has been met without requiring further user input.

In some embodiments, the one or more output devices includes an audio generation component (e.g., a speaker). In some embodiments, outputting the content includes outputting, via the audio generation component, audio (e.g., 210) (e.g., a sound, a representation of the first attribute of the first device, and/or an indication of the first attribute of the first device (e.g., a name, an absolute amount, a relative amount, a current value, and/or a voice description)). Outputting the content including outputting audio allows the computer system to enhance output and/or information assimilation by the first subject by providing audio concerning the first attribute, thereby reducing the number of inputs needed to perform an operation and/or performing an operation when a set of conditions has been met without requiring further user input.

In some embodiments, the input is a first input. In some embodiments, the computer system detects a second input corresponding to the first subject. In some embodiments, in response to detecting the second input corresponding to the first subject (and/or in accordance with a determination that a second object, different from the computer system, is with the first subject), the computer system outputs, via the one or more output devices, a second attribute (e.g., of the second object) different from the first attribute. In some embodiments, in response to detecting the second input corresponding to the first subject and in accordance with a determination that the first subject is holding the first object, the computer system outputs, via the one or more output devices, the second attribute. In some embodiments, the first input is a first type of input. In some embodiments, the second input is a second type of input different from the first type. Outputting a second attribute different from the first attribute in response to detecting a second input corresponding to the first subject provides the computer system with the ability to adapt output depending on an attribute requested by the first subject, thereby reducing the number of inputs needed to perform an operation and/or performing an operation when a set of conditions has been met without requiring further user input.

In some embodiments, in response to (304) detecting the input corresponding to the first subject, in accordance with a determination that a third object, different from the computer system and the first object, is with the first subject, the computer system outputs, via the one or more output devices, a third attribute of the third object. In some embodiments, the first attribute is a first type of attribute. In some embodiments, the second attribute is a second type of attribute different from the first type of attribute. In some embodiments, the second attribute is the first type of attribute. Outputting a third attribute of a third object when the third object is with the first subject allows the first subject to pick up and/or otherwise cause objects to be with the first subject in order to obtain attributes of the objects, thereby reducing the number of inputs needed to perform an operation and/or performing an operation when a set of conditions has been met without requiring further user input.

In some embodiments, the input is a voice input (e.g., verbal request and/or voice command) (e.g., 208). In some embodiments, the first subject requests the first attribute via a verbal request. The input being a voice input provides the computer system with increased flexibility and/or accessibility in receiving input from the first subject based on audio and/or voice, thereby reducing the number of inputs needed to perform an operation and/or providing additional control options without cluttering the user interface with additional displayed controls.

In some embodiments, the input does not include an identification of the first object (e.g., as illustrated by 208). In some embodiments, the computer system identifies the first object via the one or more input devices. The input not including an identification of the first object enables the computer system to identify the first object independently and/or without identifying information in the input received (e.g., rely on the fact that the first object is with the first subject rather than the first subject providing an indication of the first object in the input), thereby reducing the number of inputs needed to perform an operation.

In some embodiments, the one or more input devices includes a first set of one or more cameras. In some embodiments, the input is detected via the first set of one or more cameras. In some embodiments, input includes and/or is an air gesture. In some embodiments, detecting the input includes detecting movement and/or proximity of the first subject to a location in an environment (e.g., physical or virtual environment). Detecting the input via the first set of one or more cameras provides the first subject with the ability to use air gestures and/or other visual inputs to request information about the first object, thereby reducing the number of inputs needed to perform an operation and/or performing an operation when a set of conditions has been met without requiring further user input.

In some embodiments, the determination that the first object is with the first subject is performed using one or more images (e.g., of the first object and/or the first subject). In some embodiments, the computer system is in communication with a second set of one or more cameras. In some embodiments, the one or more images is captured via the second set of one or more cameras. The determination that the first object being with the first subject being performed using one or more images allows the computer system to use visual input to determine that the first object is with the first subject rather than relying on signal strength and/or confirmation by the first subject, thereby reducing the number of inputs needed to perform an operation and/or performing an operation when a set of conditions has been met without requiring further user input.

In some embodiments, the determination that the first object is with the first subject includes a determination that the first subject is holding (e.g., in a hand, a pocket, the lap, and/or a wearable item of the first subject) the first object. In some embodiments, the determination that the first object is with the first subject includes a determination that the first subject (e.g., a portion, such as a hand or finger, of the first subject) is physically and/or virtually in contact with and/or holding the first object. The determination that the first object is with the first subject including a determination that the first subject is holding the first object enables the first subject is have a particular action (e.g., holding) to cause an attribute of the first object to be output, thereby performing an operation when a set of conditions has been met without requiring further user input and/or increasing security.

In some embodiments, the first attribute is (and/or includes data) stored by the first device. In some embodiments, the first attribute is in the form of data (e.g., a number, text, and/or an image). In some embodiments, the first attribute does not include a visual attribute detectable via one or more images of the first device and/or the first subject (e.g., when, while, in conjunction with, and/or before the computer system outputs the first attribute). In some embodiments, the first attribute is persistently and/or non-persistently stored in memory (e.g., local, sensory, short-term, and/or long-term memory) of the first object. In some embodiments, the first attribute includes data such as battery life, storage capacity, signal strength, operating system information, serial number, network settings, usage information, system preferences, language settings, accessibility settings, security settings and/or health and fitness data. The first attribute being stored by the first device provides the first subject the ability to obtain data not necessarily obtainable through visual inspection, thereby performing an operation when a set of conditions has been met without requiring further user input.

In some embodiments, in response to detecting the input corresponding to the first subject and in accordance with the determination that the first object is not with the first subject, the computer system outputs, via the one or more output devices, a fourth attribute of a fourth object different from the first object. In some embodiments, the computer system outputs the fourth attribute of the fourth object in response to detecting the input corresponding to the first subject and in accordance with a determination that the fourth object is with the first subject (e.g., the first subject is holding the third object). In some embodiments, the fourth attribute is different from the first attribute, the second attribute, and/or the third attribute. In some embodiments, the third attribute is the same attribute as the first attribute, the second attribute, and/or the third attribute (e.g., but for a different device). Outputting a fourth attribute of a fourth object different from the first object in response to detecting the input corresponding to the first subject and in accordance with the determination that the first object is not with the first subject allows the computer system to adapt output depending on the object that is with the first subject (and/or whether the first object is with the first subject), thereby reducing the number of inputs needed to perform an operation and/or performing an operation when a set of conditions has been met without requiring further user input.

In some embodiments, in response to detecting the input corresponding to the first subject and in accordance with a determination that the first object is not with the first subject, the computer system outputs, via the one or more output devices, a fifth attribute of the computer system. In some embodiments, the computer system outputs the fourth attribute of the fourth object in response to detecting the input corresponding to the first subject and in accordance with a determination that no object (e.g., of a particular type) is with the first subject (e.g., the first subject is not holding an object (e.g., of the particular type)). In some embodiments, the input corresponds to the computer system (e.g., the first subject requests the fifth attribute of the computer system). Outputting a fifth attribute of the computer system in response to detecting the input corresponding to the first subject when the first object is not with the first subject allows the first subject to indicate what object is of interest to the first subject and/or when the first subject has interest with the computer system rather than some other object, thereby reducing the number of inputs needed to perform an operation, providing additional control options without cluttering the user interface with additional displayed controls, and/or performing an operation when a set of conditions has been met without requiring further user input.

Note that details of the processes described above with respect to method 300 (e.g., FIG. 3) are also applicable in an analogous manner to other methods described herein. For example, method 400 optionally includes one or more of the characteristics of the various methods described above with reference to method 300. For example, the computer system of method 300 can be the computer system of method 200. For brevity, these details are not repeated below.

FIGS. 4A-4D illustrate techniques for controlling computer systems in accordance with some embodiments. The user interfaces in these figures are used to illustrate the processes described below, including the processes in FIGS. 5-6.

FIGS. 4A-4D illustrate third computer system 406 responding to different inputs. In some embodiments, third computer system 406 is a television that includes one or more components and/or features described above in relation to electronic device 100. It should be recognized that third computer system 406 can be other types of electronic devices, including an ear bud, an ear bud case, a headphone, a smart phone, a smart watch, a smart display, a smart speaker, a tablet, a television, a laptop, a fitness tracking device, and/or a head-mounted display device.

While discussed below that a controller device detects requests and, in response, causes operations to be performed, it should be recognized that one or more other computer systems can detect sensor data, communicate the sensor data, detect a request using the sensor data, communicate an identification of the request, detect an attention of a subject, send an identification of the attention of the subject, determine an operation to perform in response to the request, and/or cause third computer system 406 to perform the operation. For example, third computer system 406 can detect a request and, in response, perform an operation when an attention of a subject corresponding to the request is on a particular object. For another example, an ecosystem can include a camera for capturing media (e.g., one or more images and/or a video) of an environment, a controller device (e.g., as described further below) for detecting a request in the media and causing third computer system 406 to perform an operation based on detecting the request. For another example, a subject can be wearing a head-mounted display device that includes a camera for detecting requests by the subject and an attention of the subject. The head-mounted display device can receive content (e.g., one or more images and/or a video) from the camera, identify an attention of the subject in the content, and cause third computer system 406 to perform an operation based on the attention. For another example, a subject can be wearing a smart watch that includes a gyroscope for capturing an attention of the subject. The smart watch can receive sensor data from the gyroscope, identify the attention of the subject using the sensor data, send an identification of the attention to another computer system (e.g., a smart phone) so that the smart phone can cause third computer system 406 to perform different operations based on the attention.

As illustrated in FIG. 4A, subject 202 is holding object 402 in environment 400. In some embodiments, object 402 is established to correspond to third computer system 406, as discussed further below. Object 402 can be a physical or virtual object, such as a soccer ball, a coaster, and/or an orb. Object 402 can be an electrical and/or non-electrical object. In some embodiments, object 402 is in communication or is able to be in communication with one or more computer systems, such as third computer system 406 and/or a controller device (sometimes used to refer to third computer system 406 or another computer system different from third computer system 406). It should be recognized that such examples of object 402 are for discussion purposes and that other objects can be used with techniques described herein. Examples of environment 400 include a room of a home, an office, and/or an outdoor park. It should be recognized that environment 400 can be any physical space and/or virtual space.

As illustrated in FIG. 4A, environment 400 includes third computer system 406, which is displaying user interface 408 with a star. In some embodiments, the star is part of a video being output by third computer system 406, the video including both visual components (e.g., the star) and acoustic components (e.g., audio being output by a speaker of and/or in communication with third computer system 406).

As illustrated in FIG. 4A, subject 202 verbally asks request 404 (e.g., “turn the volume up”). Notably, request 404 does not refer to which computer system that subject 202 is referring to. Instead, request 404 is generic in that request 404 could correspond to any of many computer systems, including third computer system 406 and/or another computer system different from third computer system 406. In some embodiments, request 404 is directed to the controller device, such as based on subject 202 causing the controller device to listen for request 404 via a press of a physical button, a tap of a user-interface element, and/or a verbal input including a keyword. In other embodiments, request 406 is not directed to the controller device but rather the controller device determines and/or is selected to respond to request 404. It should be recognized that verbally asking request 404 is just one form of input and that other types of input can be used with techniques described herein, including an input detected via a touch-sensitive surface, a physical input mechanism (e.g., a physical button and/or slider), and/or a camera (e.g., an air gesture). At FIG. 4A, the controller device detects (e.g., via a microphone of and/or in communication with the controller device) request 404.

As illustrated in FIG. 4B, in response to detecting request 404, the controller device causes (e.g., without using, without being via, and/or without communicating with object 402) third computer system 406 to display indication 412 to represent that third computer system 406 has turned up a volume level corresponding to third computer system 406. In some embodiments, the controller causes one or more other operations to be performed in addition to and/or instead of displaying indication 412, such as displaying an indication corresponding to an operation performed via a display generation component of and/or in communication with the controller device (e.g., not third computer system 406), turning up the volume level corresponding to third computer system 406, turning on or off a light, changing a brightness level of a lamp, and/or changing a channel shown on a television.

Notably, the controller device controls third computer system 406 even though request 404 did not include an indication of third computer system 406. In some embodiments, the controller device detects an attention of subject 202 in order to determine which computer system that request 404 corresponds. For explanatory purposes, the attention of subject 202 can be determined to correspond to an object (e.g., object 402) that is being held by, looked at, touched by, pointed at, and/or within a predefined distance from subject 202 (e.g., as detected in an image of environment 400 and/or signal strength between the controller device and the object).

In some embodiments, different forms of attention can take precedent over other forms of attention depending on a current context (e.g., a state of environment 400, a state of subject 202, content of request 404, and/or a state of a computer system, such as the controller device and/or third computer system 406). For example, if subject 202 is holding object 402 and is directing their gaze to a speaker in environment 400, request 404 can be determined to correspond to third computer system 406 as a result of subject 202 holding object 402. It should be recognized that other ways to detect the attention of subject 202 can be used with techniques described herein.

In some embodiments, in response to detecting request 404 and based on the attention of subject 202 being determined to not correspond to object 402 (e.g., subject 202 is not holding object 402), the controller device would not control (e.g., change a volume level of) third computer system 406. In some embodiments, instead of controlling third computer system 406 in response to detecting request 404, the controller device would control the controller device (e.g., when the attention of subject 202 is determined to correspond to the controller device and/or no computer system in environment 400) or another computer system in environment 400 (e.g., when the attention of subject 202 is determined to correspond to the other computer system, such as when subject 202 is holding an object corresponding to the other computer system).

In some embodiments, different types and/or forms of inputs are configured for a subject (e.g., subject 202), such that a first set of one or more types and/or forms of inputs are ignored for a first subject but not ignored for a second subject different from the first subject. For example, verbal inputs can be defined for the first subject and air gestures can be defined for the second subject. In such an example, when detecting verbal inputs, a corresponding operation can be performed when the verbal inputs are from the first subject but not from the second subject (e.g., when the first subject and/or the second subject is holding object 402, as discussed above). Further, when detecting air gestures, a corresponding operation can be performed when the air gestures are from the second subject but not from the first subject (e.g., when the first subject and/or the second subject is holding object 402, as discussed above).

In some embodiments, types and/or forms of inputs are specific to a set of one or more computer systems and/or when particular objects are used for correspondence to perform operations (e.g., as discussed herein), such that a first set of one or more types and/or forms of inputs are ignored for a first set of one or more computer systems but not ignored for a second set of one or more computer systems different from the first set of one or more computer systems. For example, the first set of one or more types and/or forms of inputs can include a touch input detected via a touch-sensitive surface and the second set of one or more types and/or forms of inputs can include a gaze input. In such an example, a touch input can be ignored when used to control the first set of one or more computer systems but not ignored when used to control the second set of one or more computer system. Further, a gaze input can be ignored when used to control the second set of one or more computer systems but not ignored when used to control the first set of one or more computer system. In some embodiments, such types and/or forms of inputs discussed in this paragraph are defined in a profile and/or account (e.g., a set of data defining an interaction modality) for the subject that is stored and/or accessible by the controller device, such that different subjects have different profiles and/or accounts. In some embodiments, the controller device (and/or another computer system) can change the profile and/or account for the subject based on a set of one or more inputs (e.g., from the subject), such that different types and/or forms of inputs can be used for the subject and/or for a set of one or more computer systems.

As illustrated in FIG. 4B, subject 202 verbally asks request 410 (e.g., “change remote control”). In some embodiments, request 410 does not refer to which computer system that subject 410 is referring to. Instead, request 410 is generic in that request 410 could correspond to any of many computer systems, including third computer system 406 and/or another computer system from third computer system 406. In such embodiments, some techniques described herein can require that the attention of subject 202 corresponds to object 402, as discussed above. In other embodiments, request 410 is not generic in that request 410 includes an indication of object 402 and/or third computer system 406. In such embodiments, some techniques described herein do not require that the attention of subject 202 corresponds to object 402. In some embodiments, request 410 is directed to third computer system 406, such as based on subject 202 causing third computer system 406 to listen for request 410 via a press of a physical button, a tap of a user-interface element, and/or a verbal input including a keyword. In other embodiments, request 410 is not directed to third computer system 406 but rather third computer system 406 determines and/or is selected to respond to request 410. In some embodiments, request 410 corresponds to a request to add a new control (e.g., for third computer system 406). In such embodiments, a control (and/or the new control) is used as a remote control and/or indication of the attention of subject 202 when subject 202 wishes to control third computer system 406, as described above with respect to object 402. It should be recognized that verbally asking request 410 is just one form of input and that other types of input can be used with techniques described herein, including an input detected via a touch-sensitive surface, a physical input mechanism (e.g., a physical button and/or slider), and/or a camera (e.g., an air gesture). At FIG. 4B, third computer system 406 detects (e.g., via a microphone of and/or in communication with third computer system 406) request 410.

In some embodiments, in response to detecting request 410, third computer system 406 detects attention of subject 202. For example, subject 202 can put down object 402 and pick up another object (e.g., object 414, as discussed further below). In such an example, the attention of subject 202 can be determined to correspond to the other object, indicating that subject 202 is requesting that the other object becomes a control for third computer system 406 (e.g., a remote control, as discussed above with respect to object 402 for FIGS. 4A-4B). For another example, subject 202 can verbally identify an object to be a control for third computer system 406 and/or verbally indicate that “this is the new control” while subject 202 holds the other object. It should be recognized that a process to add a new control (e.g., to be used with respect to techniques described above with respect to having the attention of subject 202 while making different requests) can be different than described in this paragraph, including using a set of one or more inputs with respect to one or more user interfaces. For discussion purposes below, object 414 will be used as a new control for third computer system 406.

In some embodiments, when adding a new control, one or more previous controls are no longer configured for third computer system 406. For example, after adding a new control, subject 202 holding object 402 can no longer be used to indicate the attention of subject 202 corresponds to third computer system 406 (and/or that subject 202 wishes to control third computer system 406). In some embodiments, when adding a new control, one or more previous controls are still configured for third computer system 406. For example, after adding a new control, subject 202 holding object 402 and/or object 414 can be used to indicate that the attention of subject 202 corresponds to third computer system 406 (and/or that subject 202 wishes to control third computer system 406).

As illustrated in FIG. 4C, subject 202 is holding object 414 in environment 400. In some embodiments, object 414 is established to correspond to third computer system 406, as discussed above with respect to adding a new control. Object 414 can be a physical or virtual object, such as a pen, a pencil, a smart phone, and/or a television control. Object 414 can be an electrical and/or non-electrical object. In some embodiments, object 414 is in communication or is able to be in communication with one or more computer systems, such as third computer system 406 and/or the controller device. It should be recognized that such examples of object 414 are for discussion purposes and that other objects can be used with techniques described herein.

As illustrated in FIG. 4C, third computer system 406 is displaying user interface 408 with a star. As mentioned above, in some embodiments, the star is part of a video being output by third computer system 406, the video including both visual components (e.g., the star) and acoustic components (e.g., audio being output by a speaker of and/or in communication with third computer system 406).

As illustrated in FIG. 4C, subject 202 verbally asks request 416 (e.g., “turn the volume down”). Notably, request 416 does not refer to which computer system that subject 202 is referring to. Instead, request 416 is generic in that request 416 could correspond to any of many computer systems, including third computer system 406 and/or another computer system different from third computer system 406. In some embodiments, request 416 is directed to the controller device, such as based on subject 202 causing the controller device to listen for request 416 via a press of a physical button, a tap of a user-interface element, and/or a verbal input including a keyword. In other embodiments, request 416 is not directed to the controller device but rather the controller device determines and/or is selected to respond to request 416. It should be recognized that verbally asking request 416 is just one form of input and that other types of input can be used with techniques described herein, including an input detected via a touch-sensitive surface, a physical input mechanism (e.g., a physical button and/or slider), and/or a camera (e.g., an air gesture). At FIG. 4C, the controller device detects (e.g., via a microphone of and/or in communication with the controller device) request 416.

As illustrated in FIG. 4D, in response to detecting request 416, the controller device causes (e.g., without using, being via, and/or communicating with object 414 and/or object 402) third computer system 406 to display indication 418 to represent that third computer system 406 has turned down a volume level corresponding to third computer system 406. In some embodiments, the controller causes one or more other operations to be performed in addition to and/or instead of displaying indication 418, such as turning down the volume level corresponding to third computer system 406, turning on or off a light, changing a brightness level of a lamp, and/or changing a channel shown on a television.

Notably, the controller device controls third computer system 406 even though request 416 did not include an indication of third computer system 406. In some embodiments, the controller device detects the attention of subject 202 to determine which computer system that request 416 corresponds. For explanatory purposes, the attention of subject 202 can be determined to correspond to an object (e.g., object 414) that is being held by, looked at, touched by, pointed at, and/or within a predefined distance from subject 202 (e.g., as detected in an image of environment 400 and/or signal strength between the controller device and the object).

In some embodiments, different forms of attention can take precedent over other forms of attention depending on a current context (e.g., a state of environment 400, a state of subject 202, content of request 416, and/or a state of a computer system, such as the controller device and/or third computer system 406). For example, if subject 202 is holding object 414 and is directing their gaze to a speaker in environment 400, request 416 can be determined to correspond to third computer system 406 as a result of subject 202 holding object 414. It should be recognized that other ways to detect the attention of subject 202 can be used with techniques described herein.

In some embodiments, in response to detecting request 416 and based on the attention of subject 202 being determined to not correspond to object 414 (and/or object 402) (e.g., subject 202 is not holding object 414 and/or object 402), the controller device would not control (e.g., change a volume level of) third computer system 406. In some embodiments, instead of controlling third computer system 406 in response to detecting request 416, the controller device would control the controller device (e.g., when the attention of subject 202 is determined to correspond to the controller device and/or no computer system in environment 400) or another computer system in environment 400 (e.g., when the attention of subject 202 is determined to correspond to the other computer system, such as when subject 202 is holding an object corresponding to the other computer system).

While the above discussion describes requests corresponding to different operations (e.g., increasing and/or decreasing a volume level), it should be recognized that requests can be detected that correspond to the same operation (e.g., increasing and/or decreasing a volume level) to cause the same operation to be performed with respect to the same computer system and/or different computer systems depending on the attention of subject 202. For example, request 402 and request 416 can both correspond to increasing a volume level, both causing third computer system 406 to increase a volume level corresponding to third computer system 406 when object 402 or object 414 is being held by subject 402. For another example, a first speaker can correspond to a pen such that when the pen is being held by subject 202 that the first speaker has its volume increased, and a second speaker can correspond to a pencil such that when the pencil is being held by subject 202 that the second speaker has its volume increased.

While the above discussion describes third computer system 406 being controlled based on attention of subject 202, it should be recognized that, in some embodiments, third computer system 406 can be controlled using existing techniques, including tapping a user-interface element on a remote control of third computer system 406 and/or pushing a button on third computer system 406 regardless of the attention of subject 202.

FIG. 5 is a flow diagram illustrating a method (e.g., method 500) for controlling computer systems in accordance with some embodiments. Some operations in method 500 are, optionally, combined, the orders of some operations are, optionally, changed, and some operations are, optionally, omitted.

As described below, method 500 provides an intuitive way for controlling computer systems. Method 500 reduces the cognitive burden on a user for controlling computer systems, thereby creating a more efficient human-machine interface. For battery-operated computing devices, enabling a user to control computer systems faster and more efficiently conserves power and increases the time between battery charges.

In some embodiments, method 500 is performed at a computer system (e.g., the controller device as described herein) that is in communication with one or more input devices (e.g., a camera, a depth sensor, a touch-sensitive surface, a hardware input mechanism, a rotatable input mechanism, and/or a microphone). In some embodiments, the computer system is an accessory, a controller, a fitness tracking device, a watch, a phone, a tablet, a processor, a head-mounted display (HMD) device, and/or a personal computing device.

The computer system detects (502), via the one or more input devices (e.g., a first camera), a first input (e.g., a tap input and/or a non-tap input (e.g., a voice command or request, a swipe input, a hold-and-drag input, a gaze input, an air gesture, and/or a mouse click)) (e.g., holding object 402) directed to (e.g., while holding and/or attention of a subject is directed to) a first object (e.g., a physical object, a virtual object, a remote control, a non-electrical object, and/or an electrical object) (e.g., 402) associated with (e.g., corresponding to, set to have a relationship with, in communication with, and/or configured with) a device (e.g., the computer system and/or another computer system different from the computer system) (e.g., 406). In some embodiments, the device is an accessory, a controller, a fitness tracking device, a watch, a phone, a tablet, a processor, a head-mounted display (HMD) device, and/or a personal computing device. In some embodiments, the first object is not in communication (e.g., wireless and/or wired communication) with the computer system and/or the device.

While detecting the first input directed to the first object (and/or after detecting initiation of the first input), the computer system detects (504), via the one or more input devices (e.g., the first camera and/or another camera different from the first camera) (e.g., a microphone), a second input (e.g., a tap input and/or a non-tap input (e.g., a verbal command or request, a swipe input, a hold-and-drag input, a gaze input, an air gesture, and/or a mouse click)) (e.g., 404) different from the first input. In some embodiments, the second input is a different type of input than the first input.

In response to (506) detecting the second input, in accordance with a determination that a user account (e.g., an account, a user profile, a profile, and/or a set of one or more settings) includes a first set of data (e.g., defining an interaction modality for a subject (e.g., a user, a person, an animal, and/or a device)) (e.g., a set of one or more settings and/or options) and that the second input is a first type (e.g., movement (e.g., via a camera or input device), voice (e.g., via a microphone), gaze, and/or push of a button) (e.g., modality, manner, style, input type, and/or type of request) (e.g., and not another type different from the first type), the computer system causes (508) the device to perform a first operation (e.g., display indication 412). In some embodiments, the computer system is logged into the user account. In some embodiments, the device is logged into the user account. In some embodiments, the device is not logged into the user account.

In response to (506) detecting the second input, in accordance with a determination that the user account includes a second set of data different from the first set of data (e.g., and does not include the first set of data) and that the second input is the first type (e.g., and not another type different from the first type), the computer system forgoes (510) causing the device to perform the first operation.

In response to (506) detecting the second input, in accordance with a determination that the user account includes the second set of data (e.g., and does not include the first set of data) and that the second input is a second type different from the first type (e.g., and not the first type), the computer system causes (512) the device to perform the first operation. Detecting an input directed to an object associated with a device (e.g., accessory) enables the user to communicate (and/or control) the device via the computer system without having to interact with the device directly, thereby reducing the number of inputs needed to perform an operation, performing an operation when a set of conditions has been met without requiring further user input, and/or providing additional control options without cluttering the user interface with additional displayed controls. Causing the device to perform an operation and/or not perform an operation via the computer system based on the user account including a particular set of data and an input being a particular type of input enables the computer system to cater its operation to a particular subject and ignore certain types of inputs for certain subjects, thereby reducing the number of inputs needed to perform an operation, providing improved feedback to the user, and/or performing an operation when a set of conditions has been met without requiring further user input.

In some embodiments, the first type (and/or the second type) is (and/or corresponds to and/or includes) a verbal input (e.g., a voice input and/or auditory input) (e.g., a verbal request and/or a verbal command) (e.g., detected via a microphone). In some embodiments, the second type (and/or the first type) is (and/or corresponds to and/or includes) a gaze input (e.g., eye-gaze and/or dwell input, look-based input, and/or eye look and/or gaze for a predetermined amount of time) (e.g., detected via a camera). In some embodiments, the second type (and/or first type) is (and/or corresponds to and/or includes) an air gesture (e.g., non-touch input, non-voice input, and/or non-gaze input) (e.g., a hand gesture to pick up, a hand gesture to press, an air tap, an air drag, an air pinch, an air swipe, and/or a clench and hold air gesture) (e.g., detected via a camera). In some embodiments, the second type (and/or the first type) is (and/or corresponds to and/or includes) detected via a hardware mechanism (e.g., a physical mechanism, a rotatable input mechanism, a button, and/or a physical slider).

In some embodiments, in response to detecting the second input and in accordance with a determination that the user account includes the first set of data (e.g., and does not include the second set of data) and that the second input is the second type (e.g., and not the first type), the computer system forgoes cause of the device to perform the first operation. In some embodiments, in response to detecting the second input and in accordance with a determination that the user account includes the first set of data (e.g., and does not include the second set of data) and that the second input is the second type (e.g., and not the first type), the computer system performs an operation while forgoing causing the device to perform the first operation. In some embodiments, in response to detecting the second input and in accordance with a determination that the user account includes the first set of data (e.g., and does not include the second set of data) and that the second input is the second type (e.g., and not the first type), the computer system causes (e.g., the device or another device different from the device) another operation different from the first operation while forgoing causing the device to perform the first operation. In some embodiments, in response to detecting the second input and in accordance with a determination that the user account includes the first set of data (e.g., and does not include the second set of data) and that the second input is the second type (e.g., and not the first type), the computer system does not perform an operation while forgoing causing the device to perform the first operation. Not causing the device to perform an operation via the computer system based on the user account including a particular set of data and an input being a particular type of input enables the computer system to cater its operation to a particular subject and ignore certain types of inputs for certain subjects as, in some embodiments, those types of inputs were not an intended input and/or incorrect input, thereby providing improved feedback to the user and/or reducing the number of inputs needed to perform an operation (e.g., undo an unintended operation).

In some embodiments, in response to detecting the second input and in accordance with a determination that the user account includes the first set of data (e.g., and does not include the second set of data) and that the second input is the second type (e.g., and not the first type), the computer system causes the device to perform the first operation. In some embodiments, in response to detecting the second input and in accordance with a determination that the user account includes the first set of data (e.g., and does not include the second set of data) and that the second input is the second type (e.g., and not the first type), the computer system performs an operation while the device performs (and/or before, after, and/or while the computer causes the device to perform) the first operation. In some embodiments, in response to detecting the second input and in accordance with a determination that the user account includes the first set of data (e.g., and does not include the second set of data) and that the second input is the second type (e.g., and not the first type), the computer system does not perform an operation while the device performs (and/or before, after, and/or while the computer causes the device to perform) the first operation. Causing the device to perform the first operation via the computer system based on the user account including the first set of data and the second input being the second type of input provides the user with control of the device and enables the computer system to cater its operation to a particular subject and perform different operations for different subjects using the same type of input, thereby reducing the number of inputs needed to perform an operation, providing improved feedback to the user, and/or performing an operation when a set of conditions has been met without requiring further user input.

In some embodiments, in response to detecting the second input and in accordance with a determination that the user account includes the first set of data (e.g., and does not include the second set of data) and that the second input is the second type (e.g., and not the first type), the computer system causes the device to perform a second operation different from the first operation. In some embodiments, in response to detecting the second input and in accordance with a determination that the user account includes the first set of data (e.g., and does not include the second set of data) and that the second input is the second type (e.g., and not the first type), the computer system performs an operation while the device performs (and/or before, after, and/or while the computer causes the device to perform) the second operation. In some embodiments, in response to detecting the second input and in accordance with a determination that the user account includes the first set of data (e.g., and does not include the second set of data) and that the second input is the second type (e.g., and not the first type), the computer system does not perform an operation while the device performs (and/or before, after, and/or while the computer causes the device to perform) the second operation. Causing the device to perform a different operation via the computer system based on the user account including the first set of data and the second input being the second type of input provides the user with control of the device and enables the computer system to cater its operation to a particular subject and perform different operations for different subjects using the same type of input, thereby reducing the number of inputs needed to perform an operation, providing improved feedback to the user, and/or performing an operation when a set of conditions has been met without requiring further user input.

In some embodiments, in response to detecting the second input and in accordance with a determination that the user account includes the first set of data (e.g., and does not include the second set of data) and that the second input is the second type (e.g., and not the first type), the computer system performs a third operation without causing the device to perform an operation (e.g., the first operation, another operation different from the first operation, and/or any operation). Causing the computer system to perform an operation without causing the device to perform an operation based on the user account including the first set of data and the second input being the second type of input allows the computer system to determine that the input is intended for the computer system and not the device and perform an operation on the computer system without causing an operation to be performed by the device, thereby reducing the number of inputs needed to perform an operation, providing improved feedback to the user, and/or performing an operation when a set of conditions has been met without requiring further user input.

In some embodiments, in response to detecting the second input and in accordance with a determination that the user account includes the second set of data (e.g., and does not include the first set of data) and that the second input is the first type (e.g., and not the second type), the computer system causes the device to perform a fourth operation different from the first operation (e.g., without causing the device to perform the first operation). Causing the device to perform different operation via the computer system based on the user account including the second set of data and the second input being the first type of input provides the user with control of the device and enables the computer system to cater its operation to a particular subject and perform different operations for different subjects using the same type of input, thereby reducing the number of inputs needed to perform an operation, providing improved feedback to the user, and/or performing an operation when a set of conditions has been met without requiring further user input.

In some embodiments, in response to detecting the second input and in accordance with a determination that the user account includes the second set of data (e.g., and does not include the first set of data) and that the second input is the first type (e.g., and not the second type), the computer system performs a fifth operation without causing the device to perform an operation (e.g., the first operation, another operation different from the first operation, and/or any operation). Causing the computer system to perform an operation without causing the device to perform an operation based on the user account including the second set of data and the second input being the first type of input allows the computer system to determine that the input is intended for the computer system and not the device and perform an operation on the computer system without causing an operation to be performed by the device, thereby reducing the number of inputs needed to perform an operation, providing improved feedback to the user, and/or performing an operation when a set of conditions has been met without requiring further user input.

In some embodiments, in response to detecting the second input and in accordance with a determination that the user account includes a third set of data different from the first set of data and the second set of data (e.g., and that the second input is the first type) (e.g., and that the second input is the second type) (e.g., and that the second input is a third type different from the first type and/or the second type), the computer system causes the device to perform a fifth operation (e.g., the first operation and/or another operation different from the first operation). Causing the device to perform the fifth operation via the computer system based on the user account including the third set of data (e.g., independent of a type of input detected via the one or more input devices) provides the user with control of the device and enables the computer system to cause the device to perform an operation based on the user account and, in some embodiments, not based on the type of input, thereby reducing the number of inputs needed to perform an operation, providing improved feedback to the user, and/or performing an operation when a set of conditions has been met without requiring further user input.

In some embodiments, in response to detecting the second input and in accordance with a determination that the second input is a third type different from the first type and the second type (e.g., and that the user account includes the first set of data) (e.g., and that the user account includes the second set of data), the computer system causes the device to perform a sixth operation (e.g., the first operation and/or another operation different from the first operation). Causing the device to perform the sixth operation via the computer system based on the second input being the third type of input (e.g., independent of which set of data that the user account includes) provides the user with control of the device and enables the computer system to cause the device to perform an operation based on the type of input and, in some embodiments, not based on data included in the user account, thereby reducing the number of inputs needed to perform an operation, providing improved feedback to the user, an/or performing an operation when a set of conditions has been met without requiring further user input.

In some embodiments, while the user account includes the first set of data, the computer system detects, via the one or more input devices, a third input (e.g., a tap input and/or a non-tap input (e.g., a verbal command or request, a swipe input, a hold-and-drag input, a gaze input, an air gesture, and/or a mouse click)) (e.g., 410). In some embodiments, in response to detecting the third input, the computer system changes the user account to include the second set of data. In some embodiments, in response to detecting the third input, the computer system changes the user account to not include the first set of data. In some embodiments, after changing the user account to include the second set of data (and/or while the user account includes the second set of data) (and/or while detecting the first input directed to the first object (and/or after detecting initiation of the first input)), the computer system detects, via the one or more input devices (e.g., the first camera and/or another camera different from the first camera) (e.g., a microphone), a fourth input (e.g., a tap input and/or a non-tap input (e.g., a verbal command or request, a swipe input, a hold-and-drag input, a gaze input, an air gesture, and/or a mouse click)) (e.g., 416) different from the first input and the second input (and/or the third input). In some embodiments, the fourth input is a different type of input than the first input and/or the third input. In some embodiments, in response to detecting the fourth input, in accordance with a determination that the fourth input is the first type (e.g., and not another type different from the first type), the computer system forgoes cause of the device to perform the first operation. In some embodiments, in response to detecting the fourth input, in accordance with a determination that the fourth input is the second type (e.g., and not the first type), the computer system causes the device to perform the first operation. In some embodiments, while the user account includes the second set of data, the computer system detects a fifth input (e.g., a tap input and/or a non-tap input (e.g., a verbal command or request, a swipe input, a hold-and-drag input, a gaze input, an air gesture, and/or a mouse click)). In some embodiments, in response to detecting the fifth input, changing the user account to include the first set of data. In some embodiments, in response to detecting the fifth input, the computer system changes the user account to not include the second set of data. In some embodiments, after changing the user account to include the second set of data (and/or while the user account includes the second set of data) (and/or while detecting the first input directed to the first object (and/or after detecting initiation of the first input)), the computer system detects, via the one or more input devices (e.g., the first camera and/or another camera different from the first camera) (e.g., a microphone), a sixth input (e.g., a tap input and/or a non-tap input (e.g., a verbal command or request, a swipe input, a hold-and-drag input, a gaze input, an air gesture, and/or a mouse click)) different from the first input and the second input (and/or the third input, the fourth input, and/or the fifth input). In some embodiments, the sixth input is a different type of input than the first input. In some embodiments, in response to detecting the sixth input and in accordance with a determination that the second input is the first type (e.g., and not the second type), the computer system causes the device to perform the first operation. In some embodiments, in response to detecting the sixth input and in accordance with a determination that the second input is the second type (e.g., and not the first type), the computer system causes the device to perform the second operation different from the first operation. In some embodiments, in response to detecting the sixth input and in accordance with a determination that the second input is the second type (e.g., and not the first type), the computer system performs the third operation without causing the device to perform an operation (e.g., the first operation, another operation different from the first operation, and/or any operation). Changing the user account from including the first set of data to the second set of data based on an input provides the user with control over the user account, which, in some embodiments, changes what operations are performed with different types input, thereby performing an operation when a set of conditions has been met without requiring further user input and/or reducing the number of inputs needed to perform an operation.

In some embodiments, the computer system detects, via the one or more input devices (e.g., a first camera), a seventh input (e.g., a tap input and/or a non-tap input (e.g., a swipe input, a hold-and-drag input, a gaze input, an air gesture, and/or a mouse click)) (e.g., holding object 414) directed to a second object (e.g., a physical object, a virtual object, an non-electrical object, and/or an electrical object) (e.g., associated with (e.g., corresponding to, set to have a relationship with, in communication with, and/or configured with) the device) (e.g., 414) different from the first object. In some embodiments, the second object is not in communication (e.g., wireless and/or wired communication) with the computer system and/or the device. In some embodiments, while detecting the seventh input directed to the second object (and/or after detecting initiation of the seventh input), the computer system detects, via the one or more input devices (e.g., the first camera and/or another camera different from the first camera) (e.g., a microphone), an eighth input (e.g., a tap input and/or a non-tap input (e.g., a verbal command or request, a swipe input, a hold-and-drag input, a gaze input, an air gesture, and/or a mouse click)) (e.g., 416) different from the first input, the second input, and the seventh input. In some embodiments, the eighth input is a different type of input than the seventh input. In some embodiments, in response to detecting the eighth input, in accordance with a determination that the user account includes the first set of data (e.g., and not the second set of data) and that the eighth input is the first type (e.g., and not the second type), the computer system causes the device to perform the first operation (e.g., display indication 418). In some embodiments, in response to detecting the eighth input, in accordance with a determination that the user account includes the second set of data (e.g., and does not include the first set of data) and that the second input is the first type (e.g., and not the second type), the computer system forgoes cause of the device to perform the first operation. In some embodiments, in response to detecting the eighth input, in accordance with a determination that the user account includes the second set of data (e.g., and does not include the first set of data) and that the second input is the second type (e.g., and not the first type), the computer system causes the device to perform the first operation. Detecting an input directed at a second object different from the first object that is also configured to control the device (e.g., in a similar or same manner as the first object) provides the user with an alternative control associated with the same device, thereby providing additional control options for the user.

In some embodiments, the first object (and/or the second object) is not in communication with the computer system. In some embodiments, the first object (and/or the second object) is not in communication with the device.

In some embodiments, the device is a first device. In some embodiments, the computer system detects, via the one or more input devices (e.g., a first camera), a ninth input (e.g., a tap input and/or a non-tap input (e.g., a swipe input, a hold-and-drag input, a gaze input, an air gesture, and/or a mouse click)) directed to a third object (e.g., a physical object, a virtual object, an non-electrical object, and/or an electrical object) different from the first object (and/or the second object). In some embodiments, while detecting the ninth input directed to the third object (and/or after detecting initiation of the ninth input), the computer system detects, via the one or more input devices (e.g., the first camera and/or another camera different from the first camera) (e.g., a microphone), a tenth input (e.g., a tap input and/or a non-tap input (e.g., a verbal command or request, a swipe input, a hold-and-drag input, a gaze input, an air gesture, and/or a mouse click)) different from the first input, the second input, the seventh input, and the ninth input. In some embodiments, the tenth input is a different type of input than the ninth input. In some embodiments, in response to detecting the tenth input, in accordance with a determination that the user account includes the first set of data (e.g., and not the second set of data) and that the tenth input is the first type (e.g., and not the second type), the computer system causes a second device to perform the first operation, wherein the second device is different from the first device. In some embodiments, the third object is associated with (e.g., corresponding to, set to have a relationship with, in communication with, and/or configured with) the second device. In some embodiments, the third object is not in communication (e.g., wireless and/or wired communication) with the computer system and/or the second device. In some embodiments, in response to detecting the tenth input, in accordance with a determination that the user account includes the second set of data (e.g., and does not include the first set of data) and that the tenth input is the first type (e.g., and not the second type), the computer system forgoes cause of the second device to perform the first operation. In some embodiments, in response to detecting the tenth input, in accordance with a determination that the user account includes the second set of data (e.g., and does not include the first set of data) and that the tenth input is the second type (e.g., and not the first type), the computer system causes the second device to perform the first operation. Detecting an input directed at a third object that is associated with a different device provides the user with additional control from the computer system to other devices, thereby reducing the number of inputs needed to perform an operation and/or providing additional control options without cluttering the user interface with additional displayed controls.

In some embodiments, detecting that the first input is directed to the first object includes detecting (and/or determining) that the first object (e.g., and/or the second object and/or the third object) is within a predefined distance from a subject (e.g., user corresponding to the user account) (e.g., corresponding to the user account) (e.g., in an environment (e.g., a physical or virtual environment) including the one or more input devices) (e.g., detecting and/or determining that the subject is holding the first object) (e.g., detecting and/or determining that the first object is near the subject). Detecting that the object is within a predefined distance from a subject allows the computer system to determine if the input was intended or not based on the predefined distance and if the object corresponds to the user, thereby increasing security of the device.

In some embodiments, the computer system detects, via the one or more input devices, an eleventh input (e.g., the same as the second input) (e.g., of the first type and/or the second type). In some embodiments, in response to detecting the eleventh input and while not detecting (e.g., via the one or more input devices) an input directed to the first object (and/or after a predetermined amount of time has lapsed since detecting an input directed to the first object) (and/or in accordance with a determination that the user account includes the first set of data and/or the second set of data), the computer system forgoes cause of the device to perform an operation (e.g., the first operation, another operation different from the first operation, and/or any operation). While not detecting an input directed to the object but detecting an input of the same type allows the computer system to determine that the input is not associated with the device and should not cause the device to perform an operation, thereby reducing the number of inputs needed to perform an operation and/or increasing security of the device.

In some embodiments, in response to detecting the eleventh input and while detecting (e.g., via the one or more input devices) an input directed to the first object (and/or before a predetermined amount of time has lapsed since detecting an input directed to the first object) (and/or in accordance with a determination that the user account includes the first set of data and/or the second set of data) (and/or in accordance with a determination that the eleventh input is the same type of input as the second input), the computer system performs a sixth operation without causing the device to perform an operation (e.g., the first operation, another operation different from the first operation, and/or any operation). While not detecting an input directed to the object but detecting an input of the same type, causing the computer system to perform an operation (1) allows the computer system to determine that the input is not associated with the device and should instead cause perform an operation itself and/or (2) provides the user with feedback that the user input is received, thereby providing improved feedback to the user and/or performing an operation when a set of conditions has been met without requiring further user input.

Note that details of the processes described above with respect to method 500 (e.g., FIG. 5) are also applicable in an analogous manner to other methods described herein. For example, method 600 optionally includes one or more of the characteristics of the various methods described above with reference to method 500. For example, the computer system of method 500 can be the computer system of method 600. For brevity, these details are not repeated below.

FIG. 6 is a flow diagram illustrating a method (e.g., method 600) for controlling computer systems in accordance with some embodiments. Some operations in method 600 are, optionally, combined, the orders of some operations are, optionally, changed, and some operations are, optionally, omitted.

As described below, method 600 provides an intuitive way for controlling computer systems. Method 600 reduces the cognitive burden on a user for controlling computer systems, thereby creating a more efficient human-machine interface. For battery-operated computing devices, enabling a user to control computer systems faster and more efficiently conserves power and increases the time between battery charges.

In some embodiments, method 600 is performed at a computer system (e.g., the controller device described herein and/or third computer system 406) that is in communication with one or more input devices (e.g., a camera, a depth sensor, and/or a microphone) and one or more output devices (e.g., a speaker, a haptic output device, a display screen, a projector, and/or a touch-sensitive display). In some embodiments, the computer system is an accessory, a controller, a fitness tracking device, a watch, a phone, a tablet, a processor, a head-mounted display (HMD) device, and/or a personal computing device.

The computer system detects (602), via the one or more input devices, an input (e.g., a tap input and/or a non-tap input (e.g., a voice command or request, a swipe input, a hold-and-drag input, a gaze input, an air gesture, and/or a mouse click)) (e.g., 404) corresponding to a request to perform an operation (e.g., turn the volume up, as described above with respect to FIG. 4A).

In response to (604) detecting the input corresponding to the request to perform the operation, in accordance with a determination that attention of a first subject (e.g., a user, a person, an animal, and/or an object) (e.g., 402) is directed to a first object (e.g., a physical object, a virtual object, a remote control, a non-electrical object, and/or an electrical object) (e.g., 402) different from (1) the computer system and (2) a first device (e.g., a computer system) different from the computer system, the computer system causes (606) the first device to perform a first operation (e.g., display indication 412). In some embodiments, the first device is an accessory, a controller, a fitness tracking device, a watch, a phone, a tablet, a processor, a head-mounted display (HMD) device, and/or a personal computing device.

In response to (604) detecting the input corresponding to the request to perform the operation, in accordance with a determination that the attention of the first subject is not directed to the first object, the computer system forgoes (608) cause of the first device to perform the first operation. Causing the first device to perform the first operation when the attention of the first subject is directed to the first object enables the computer system to cause operations to be performed by devices based on attention directed to different objects, thereby performing an operation when a set of conditions has been met without requiring further user input, providing additional control options without cluttering the user interface with additional displayed controls, and/or providing improved feedback to the user.

In some embodiments, the input is (and/or includes) a voice request (e.g., an audible command, an audible statement, and/or voice request). Causing the first device to perform the first operation in response to detecting a voice request when the determination that the attention of the first subject is directed to the first object enables the computer system to cause operations to be performed by devices based on attention directed to different objects in response to user voice requests, thereby performing an operation when a set of conditions has been met without requiring further user input, providing additional control options without cluttering the user interface with additional displayed controls, and/or providing improved feedback to the user.

In some embodiments, the input is a first input. In some embodiments, after causing the first device to perform the first operation, the computer system detects, via the one or more input devices, a request (e.g., via an input (e.g., a tap input and/or a non-tap input (e.g., a voice command or request, a swipe input, a hold-and-drag input, a gaze input, an air gesture, and/or a mouse click))) (e.g., 410 and/or as described above with respect to FIG. 4B) to designate (e.g., establish, set, and/or define), for the first device (and/or another device different from the first device), a second object (e.g., 414) different from the first device and the first object. In some embodiments, in response to detecting the request to designate the second object, the computer system designates, for the first device, the second object (e.g., instead of and/or in addition to the first object). In some embodiments, the second object is separate from the first object. In some embodiments, the second object is unrelated to the first object. In some embodiments, the second object is a different type of object than the first object. In some embodiments, after detecting the request to designate the second object, the computer system detects, via the one or more input devices, a second input (e.g., a tap input and/or a non-tap input (e.g., a voice command or request, a swipe input, a hold-and-drag input, a gaze input, an air gesture, and/or a mouse click)) (e.g., corresponding to a request to perform the first operation) (e.g., 416), wherein the second input is separate from the first input, and wherein the second input is the same type of input as the first input. In some embodiments, in response to detecting the second input and in accordance with a determination that the attention of the first subject is directed to the second object, the computer system causes the first device (and/or another device different from the first device) to perform the first operation. In some embodiments, in response to detecting the second input and in accordance with a determination that the attention of the first subject is not directed to the second object (and/or the first object), the computer system forgoes cause of the first device to perform the first operation. In some embodiments, in response to detecting the second input and in accordance with a determination that the attention of the first subject is not directed to any device (e.g., not the first device, second device, and/or a different device), the computer system forgoes causing the first device to perform the first operation. In some embodiments, before detecting the request to designate the second object, in response to detecting an input of the same type of input as the first input, and in accordance with a determination that the attention of the first object is directed to the second object, the computer system forgoes causing (e.g., does not cause) the first device to perform the first operation. Causing the first device to perform the first operation in response to detecting the second input and in accordance with the determination that the attention of the first subject is directed to the second object enables the computer system to perform the same operation based on attention directed to different objects, thereby performing an operation when a set of conditions has been met without requiring further user input, providing additional control options without cluttering the user interface with additional displayed controls, and/or providing improved feedback to the user. After detecting the request to designate the second object and in response to detecting the second input, causing the first device to perform the first operation enables to designate different objects for the same device such that the different objects can be used as an indication that subsequent input corresponds to the same device, thereby providing additional control options without cluttering the user interface with additional displayed controls and/or providing improved feedback to the user.

In some embodiments, in response to detecting the second input and in accordance with a determination that the attention of the first subject is directed to the first device, the computer system forgoes cause of the first device to perform the first operation (e.g., designating, for the first device, the second object results in the attention of the first subject directed to the first object no longer causing the first device to perform one or more operations in response to detecting one or more inputs). In some embodiments, in response to detecting the second input and in accordance with a determination that the attention of the first subject is not directed to the first device, the computer system forgoes causing the first device to perform the first operation. Forgoing causing the first device to perform the first operation in response to detecting the second input and in accordance with the determination that the attention of the first subject is directed to the first device enables the computer system to not cause operations to be performed by devices when the attention of the user is on an object no longer designated for the devices, thereby performing an operation when a set of conditions has been met without requiring further user input, providing additional control options without cluttering the user interface with additional displayed controls, and/or providing improved feedback to the user.

In some embodiments, in response to detecting the second input and in accordance with a determination that the attention of the first subject is directed to the first object (e.g., designating, for the first device, the second object does not result in the attention of the first subject directed to the first object to no longer cause the first device to perform the first operation in response to detecting one or more inputs), the computer system causes the first device to perform the first operation. Causing the first device to perform the first operation in response to detecting the second input and in accordance with the determination that the attention of the first subject is directed to the first object enables the computer system to cause operations to be performed by devices with objects previously designated for the devices even after new objects are designated for the devices, thereby performing an operation when a set of conditions has been met without requiring further user input, providing additional control options without cluttering the user interface with additional displayed controls, and/or providing improved feedback to the user.

In some embodiments, the input is a third input. In some embodiments, after causing the first device to perform the first operation (e.g., in accordance with the determination that the attention of the first subject is directed to the first object), the computer system detects, via the one or more input devices, a fourth input (e.g., directed to the first device) different from the third input. In some embodiments, in response to detecting the fourth input and in accordance with a determination that the fourth input is directed to the first device (and/or not directed to the first object) (and/or, in some embodiments, that the fourth input is not directed to the first object) (and/or irrespective of the attention of the first subject), the computer system causes the first device to perform a second operation. In some embodiments, the second operation is the same as the first operation. In some embodiments, the second operation is different from the first operation. In some embodiments, the fourth input corresponds to a request to perform the second operation. In some embodiments, the one or more input devices include a physical button (e.g., a volume button and/or a lock button), and detecting the fourth input includes detecting, via the physical button, a selection of the physical button. In some embodiments, the one or more input devices include a touch-sensitive surface, and detecting the fourth input includes detecting, via the touch-sensitive surface, a touch input. In some embodiments, the one or more input devices include a microphone, and detecting the fourth input includes detecting, via the microphone, a voice input. Causing the first device to perform the second operation in response to detecting the fourth input and in accordance with a determination that the fourth input is directed to the first device enables the computer system to not only cause operations to be performed by a specific device when the attention of the first subject is directed to an object corresponding to the specific device but also when an input is directed to the specific device, thereby performing an operation when a set of conditions has been met without requiring further user input, providing additional control options without cluttering the user interface with additional displayed controls, and/or providing improved feedback to the user.

In some embodiments, the input is a fifth input. In some embodiments, after causing the first device to perform the first operation (e.g., in accordance with the determination that the attention of the first subject is directed to the first object), the computer system detects, via the one or more input devices, a sixth input (e.g., without detecting the attention of the first subject directed to the first object) that is a different type of input (e.g., a different modality (e.g., touch input, air gesture, voice input, a gaze input, and/or physical input)) (e.g., a first air gesture and/or a first verbal request as compared to a second air gesture different from the first air gesture and/or a second verbal request different from the first verbal request) than the fifth input (e.g., the fifth input is a first type of input and the sixth input is a second type of input different from the first type of input). In some embodiments, the sixth input corresponds to a request to perform another operation different from the first operation. In some embodiments, in response to detecting the sixth input, in accordance with a determination that the attention of the first subject is not directed to the first object and that the sixth input includes a first type of input, the computer system causes the first device to perform a third operation. In some embodiments, in response to detecting the sixth input, in accordance with a determination that the attention of the first subject is not directed to the first object and that the sixth input includes a second type of input different from the first type of input, the computer system forgoes cause of the first device to perform the third operation. In some embodiments, the third operation is the same as the first operation. In some embodiments, the third operation is different from the first operation. In some embodiments, in response to detecting the sixth input and in accordance with a determination that the attention of the first subject is directed to the first object and that the sixth input includes the first type of input, the computer system causes the first device to perform the third operation. In some embodiments, in response to detecting the sixth input and in accordance with a determination that the attention of the first subject is directed to the first object and that the sixth input includes the second type of input, the computer system causes the first device to perform the third operation. Causing the first device to perform a third operation in accordance with the determination that the attention of the first subject is not directed to the first object and that the seventh input includes a first type of input and forgoing causing the first device to perform the third operation in accordance with the determination that the attention of the first subject is not directed to the first object and that the seventh input includes a second type of input different from the first type of input enables the computer system to cause a device to perform an operation when the input is a certain type, thereby performing an operation when a set of conditions has been met without requiring further user input, providing additional control options without cluttering the user interface with additional displayed controls, and/or providing improved feedback to the user.

In some embodiments, in response to detecting the input corresponding to the request to perform the operation and in accordance with a determination that the attention of the first subject is not directed to the first object, the computer system causes a fourth operation to be performed (e.g., by the first device or another device different from the first device), wherein the fourth operation is different from the first operation. In some embodiments, the fourth operation is the same as the first operation but with respect to a different device than the first device. In some embodiments, the fourth operation is a different operation than the first operation but with respect to the first device. Causing the fourth operation to be performed in response to detecting the input corresponding to the request to perform the operation and in accordance with the determination that the attention of the first subject is not directed to the first object enables the computer system to cause operations to be performed even when the attention of the first subject is not directed to the first object, thereby performing an operation when a set of conditions has been met without requiring further user input, providing additional control options without cluttering the user interface with additional displayed controls, and/or providing improved feedback to the user.

In some embodiments, causing the fourth operation to be performed includes causing the first device to perform the fourth operation. Causing the first device to perform the fourth operation in response to detecting the input corresponding to the request to perform the operation and in accordance with the determination that the attention of the first subject is not directed to the first object enables the computer system to cause operations to be performed by the first device even when the attention of the first subject is not directed to the first object, thereby performing an operation when a set of conditions has been met without requiring further user input, providing additional control options without cluttering the user interface with additional displayed controls, and/or providing improved feedback to the user.

In some embodiments, causing the fourth operation to be performed includes causing a fourth device, different from the first device and the computer system, to perform the fourth operation. Causing the fourth device to perform the fourth operation in response to detecting the input corresponding to the request to perform the operation and in accordance with the determination that the attention of the first subject is not directed to the first object enables the computer system to cause operations to be performed by another device different from the first device when the attention of the first subject is not directed to the first object, thereby performing an operation when a set of conditions has been met without requiring further user input, providing additional control options without cluttering the user interface with additional displayed controls, and/or providing improved feedback to the user.

In some embodiments, causing the fourth operation to be performed includes causing the computer system to perform the fourth operation without causing the first device to perform the fourth operation. Causing the computer system to perform the fourth operation in response to detecting the input corresponding to the request to perform the operation and in accordance with the determination that the attention of the first subject is not directed to the first object enables operations to be performed by the computer system instead of another device when the attention of the first subject is not directed to an object, thereby performing an operation when a set of conditions has been met without requiring further user input, providing additional control options without cluttering the user interface with additional displayed controls, and/or providing improved feedback to the user.

In some embodiments, the one or more input devices includes a set of one or more cameras (e.g., a telephoto camera, a wide-angle camera, and/or an ultra-wide-angle camera). In some embodiments, the determination that the attention of the first subject is directed to the first object is performed via the one or more cameras (e.g., the attention of the first subject is detected in one or more images captured by the one or more cameras). The determination that the attention of the first subject is directed to the first object being performed via the one or more cameras enables the computer system to visually ascertain the attention of the first subject without requiring the first subject to indicate their attention via touch, auditory, and/or a non-visual input, thereby performing an operation when a set of conditions has been met without requiring further user input, providing additional control options without cluttering the user interface with additional displayed controls, and/or providing improved feedback to the user.

In some embodiments, causing the first device to perform the first operation includes causing a setting (e.g., a volume setting, a brightness setting, and/or a lock state setting) of the first device to change. Causing the first device to perform the first operation including causing a setting to change when the determination that the attention of the first subject is directed to the first object enables the computer system to change a setting of a device based on attention directed to an object corresponding to the device, thereby performing an operation when a set of conditions has been met without requiring further user input, providing additional control options without cluttering the user interface with additional displayed controls, and/or providing improved feedback to the user.

In some embodiments, in response to detecting the input corresponding to the request to perform the operation and in accordance with a determination that the attention of the first subject is directed to the first object, the computer system outputs (e.g., displays, outputs audio of, and/or outputs haptic of), via the one or more output devices, an indication (e.g., 412 and/or 418) corresponding to causing (e.g., an indication that the computer system is causing, has caused, or will cause) the first device to perform the first operation. In some embodiments, the first computer system causes the first device to perform the first operation before, during, and/or after outputting the indication corresponding to causing the first device to perform the first operation. Outputting the indication corresponding to causing the first device to perform the first operation in response to detecting the input corresponding to the request to perform the operation and in accordance with the determination that the attention of the first subject is directed to the first object enables the computer system to indicate what the computer system is doing and that another device is performing an operation, thereby performing an operation when a set of conditions has been met without requiring further user input, providing additional control options without cluttering the user interface with additional displayed controls, and/or providing improved feedback to the user.

In some embodiments, the input does not include an identification (e.g., a label, name, or attribution) of the first device (e.g., the first device is identified by the attention of the first subject and not the input). Causing the first device to perform the first operation when the determination that the attention of the first subject is directed to the first object in response to detecting an input that does not include an identification of the first device enables the computer system to control devices based on attention directed to different objects without receiving the identification of the devices, thereby performing an operation when a set of conditions has been met without requiring further user input, providing additional control options without cluttering the user interface with additional displayed controls, and/or providing improved feedback to the user.

In some embodiments, the determination that the attention of the first subject is directed to the first object includes a determination that the first subject is holding the first object (e.g., the first object is in the arms of, in the pocket of, in the hands of, on the lap of, and/or attached to the first subject). The determination that the attention of the first subject is directed to the first object including a determination that the first subject is holding the first object enables the first subject to perform an explicit indication (e.g., holding) that the first object is where the attention of the subject is and/or to reduce the number of false positives with respect to where the attention of the subject is, thereby performing an operation when a set of conditions has been met without requiring further user input, providing additional control options without cluttering the user interface with additional displayed controls, and/or providing improved feedback to the user.

In some embodiments, the determination that the attention of the first subject is directed to the first object includes a determination that the first subject is looking at (e.g., the first subject's gaze is directed towards, and/or has been directed towards for a threshold period of time) the first object. The determination that the attention of the first subject is directed to the first object including a determination that the first subject is looking at the first object enables the computer system to cause operations to be performed by devices based on the object the first subject is looking at and/or not require indications of the devices and/or other physical movements to indicate which device to cause an operation to be performed by, thereby performing an operation when a set of conditions has been met without requiring further user input, providing additional control options without cluttering the user interface with additional displayed controls, and/or providing improved feedback to the user.

In some embodiments, the first object is a virtual object (e.g., not a physical object) (e.g., an object that is displayed and/or otherwise output by the computer system or another computer system different from the computer system) (e.g., an object for which is not visible without an electronic device). Causing the first device to perform the first operation when the determination that the attention of the first subject is directed to a virtual object enables the computer system to cause operations to be performed by devices based on attention directed to different virtual objects, thereby performing an operation when a set of conditions has been met without requiring further user input, providing additional control options without cluttering the user interface with additional displayed controls, and/or providing improved feedback to the user.

In some embodiments, the first object is a physical object (e.g., a real-world object) (e.g., an object that is not displayed and/or otherwise output by the computer system or another computer system different from the computer system) (e.g., an object for which is visible without an electronic device). Causing the first device to perform the first operation when the determination that the attention of the first subject is directed to a physical object enables the computer system to cause operations to be performed by devices based on attention directed to physical objects, thereby performing an operation when a set of conditions has been met without requiring further user input, providing additional control options without cluttering the user interface with additional displayed controls, and/or providing improved feedback to the user.

In some embodiments, the first object is not in communication with the computer system (and/or the first device). Causing the first device to perform the first operation in accordance with the determination that the attention of the first subject is directed to the first object when the first object is not in communication with the computer system enables the computer system to cause operations to be performed by devices based on attention directed to different objects even when an object is not in communication with the computer system (e.g., the attention is determined without being in communication with the object), thereby performing an operation when a set of conditions has been met without requiring further user input, providing additional control options without cluttering the user interface with additional displayed controls, and/or providing improved feedback to the user.

In some embodiments, the first object is in communication with the computer system (and/or the first device). Causing the first device to perform the first operation in accordance with the determination that the attention of the first subject is directed to the first object when the first object is in communication with the computer system enables the computer system to cause operations to be performed by devices based on attention directed to different objects that the computer system is communicating with, thereby performing an operation when a set of conditions has been met without requiring further user input, providing additional control options without cluttering the user interface with additional displayed controls, and/or providing improved feedback to the user.

In some embodiments, causing the first device to perform the first operation is not performed via the first object (e.g., a communication is not sent to and/or through the first object to cause the first device to perform the first operation). Causing the first device to perform the first operation not via the first object when the determination that the attention of the first subject is directed to the first object enables the computer system to directly cause operations to be performed by devices based on attention directed to different objects without using the object as an intermediary to the device, thereby performing an operation when a set of conditions has been met without requiring further user input, providing additional control options without cluttering the user interface with additional displayed controls, and/or providing improved feedback to the user.

In some embodiments, the input is a seventh input. In some embodiments, after causing the first device to perform the first operation in response to detecting the seventh input corresponding to the request to perform the operation and in accordance with the determination that the attention of the first subject is directed to the first object, the computer system detects, via the one or more input devices, an eighth input (e.g., different and/or separate from the seventh input) (e.g., a tap input and/or a non-tap input (e.g., a voice command or request, a swipe input, a hold-and-drag input, a gaze input, an air gesture, and/or a mouse click)). In some embodiments, the eighth input corresponds to the request to perform the operation. In some embodiments, the eighth input is the same as the seventh input. In some embodiments, in response to detecting the eighth input and in accordance with a determination that the attention of the first subject is directed to a third object different from the computer system, the first device, and a fifth device different from the first device, the computer system causes the fifth device to perform a fifth operation (e.g., the first operation or another operation different from the fifth operation). Causing the fifth device to perform the fifth operation in response to detecting the fourth input and in accordance with the determination that the attention of the first subject is directed to the third object enables the computer system to cause operations to be performed by devices when the attention of the user moves from one object to another and another input is detected, thereby performing an operation when a set of conditions has been met without requiring further user input, providing additional control options without cluttering the user interface with additional displayed controls, and/or providing improved feedback to the user.

Note that details of the processes described above with respect to method 600 (e.g., FIG. 6) are also applicable in an analogous manner to the methods described herein. For example, method 300 optionally includes one or more of the characteristics of the various methods described above with reference to method 600. For example, the first attribute of method 300 can be output as part of performance of the first operation of method 600. For brevity, these details are not repeated below.

The operations described above can be performed using various ecosystems of devices. Conceptually, a source device obtains and delivers data representing the environment to a decision controller. In the foregoing examples, for instance, an accessory device in the form of a camera acts as a source device by providing camera output about the environment described above with respect to FIGS. 2A-2B, 3, 4A-4D, 5, and/or 6. The camera output can be provided to a controller device with sufficient computation power to process the incoming information and generate instructions for other devices in the environment. Examples of electronic devices having sufficient computational power to act as controllers include a smart phone, a smart watch, a smart display, a tablet, a laptop, a head-mounted display device, and/or a desktop computer. Controller functionality may also be integrated into devices that have other primary functionalities, such as a media playback device, a smart speaker, a tabletop dock or smart screen, and/or a television. Source devices, such as the camera, can in some instances have sufficient computational power to act as controller devices. It should be appreciated that computational power generally represents a design choice that is balanced with power consumption, packaging, and/or cost. For example, a source device that is wired to main electricity may be more likely to take on controller device functionality than a battery-powered device, even though both are possible. The controller device, upon determining a decision based on the obtained sensor output, provides instructions to be processed by one or more other devices in the environment (e.g., first computer system 204, second computer system 206, and/or third computer system 406). In the foregoing examples, the controller device provides first computer system 206 with an identification of a computer system (e.g., second computer system 206) with subject 202 or causes third computer system 406 to display perform an operation such as increase or decrease volume.

The various ecosystems of devices described above can connect and communicate with one another using various communication configurations. Some exemplary configurations involve direct communications such as device-to-device connections. For example, a source device (e.g., camera) can capture images of an environment, determine an air gesture performed by a particular subject and, acting as a controller device, determine to send an instruction to a computer system to change states. The connection between the source device and the computer system can be wired or wireless. The connection can be a direct device-to-device connection such as Bluetooth. Some exemplary configurations involve mesh connections. For example, a source device may use a mesh connection such as Thread to connect with other devices in the environment. Some exemplary configurations involve local and/or wide area networks and may employ a combination of wired (e.g., Ethernet) and wireless (e.g., Wi-Fi, Bluetooth, Thread, and/or UWB) connections. For example, a camera may connect locally with a controller hub in the form of a smart speaker, and the smart speaker may relay instructions remotely with a smart phone, over a cellular or Internet connection.

As described above, the present technology contemplates the gathering and use of data available from various sources, including cameras, to improve interactions with connected devices. In some instances, these sources may include electronic devices situated in an enclosed space such as a room, a home, a building, and/or a predefined area. Cameras and other connected, smart devices offer potential benefit to users. For example, security systems often incorporate cameras and other sensors. Accordingly, the use of smart devices enables users to have calculated control of benefits, include detecting air gestures, in their environment. Other uses for sensor data that benefit the user are also contemplated by the present disclosure. For instance, health data may be used to provide insights into a user's general wellness.

Entities responsible for implementing, collecting, analyzing, disclosing, transferring, storing, or otherwise using camera images or other data containing personal information should comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, camera images or personal information data. For example, in the case of device control services, the present technology can be configured to allow users to select to “opt in” or “opt out” of participation during registration for services or anytime thereafter. In another example, users can selectively enable certain device control services while disabling others. For example, a user may enable detecting air gestures with depth sensors but disable camera output.

Implementers may also take steps to anonymize sensor data. For example, cameras may operate at low resolution for automatic object detection, and capture at higher resolutions upon explicit user instruction. Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., name and location), controlling the amount or specificity of data stored (e.g., collecting location data a city level rather than at an address level), controlling how data is stored (e.g., aggregating data across users), and/or other methods.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

What is claimed is:

1. A method, comprising:
at a computer system that is in communication with one or more input devices and one or more output devices:
detecting, via the one or more input devices, an input corresponding to a first subject; and
in response to detecting the input corresponding to the first subject:
in accordance with a determination that a first object, different from the computer system, is with the first subject, outputting, via the one or more output devices, a first attribute of the first object; and
in accordance with a determination that the first object is not with the first subject, forgoing outputting, via the one or more output devices, the first attribute of the first object.

2. The method of claim 1, wherein the first object is not in communication with the computer system while detecting the input corresponding to the first subject.

3. The method of claim 1, wherein the first object is in communication with the computer system.

4. The method of claim 1, wherein the first object is a physical object.

5. The method of claim 1, wherein the first object is a virtual object.

6. The method of claim 1, wherein the one or more output devices includes a display generation component, and wherein outputting the first attribute of the first device includes displaying, via the display generation component, an indication of the first attribute of the first device.

7. The method of claim 1, wherein the one or more output devices includes an audio generation component, and wherein outputting the content includes outputting, via the audio generation component, audio.

8. The method of claim 1, wherein the input is a first input, the method further comprising:
detecting a second input corresponding to the first subject; and
in response to detecting the second input corresponding to the first subject, outputting, via the one or more output devices, a second attribute different from the first attribute.

9. The method of claim 1, further comprising:
in accordance with a determination that a third object, different from the computer system and the first object, is with the first subject, outputting, via the one or more output devices, a third attribute of the third object.

10. The method of claim 1, wherein the input is a voice input.

11. The method of claim 1, wherein the input does not include an identification of the first object.

12. The method of claim 1, wherein the one or more input devices includes a first set of one or more cameras, and wherein the input is detected via the first set of one or more cameras.

13. The method of claim 1, wherein the determination that the first object is with the first subject is performed using one or more images.

14. The method of claim 1, wherein the determination that the first object is with the first subject includes a determination that the first subject is holding the first object.

15. The method of claim 1, wherein the first attribute is stored by the first device.

16. The method of claim 1, further comprising:
in response to detecting the input corresponding to the first subject and in accordance with the determination that the first object is not with the first subject, outputting, via the one or more output devices, a fourth attribute of a fourth object different from the first object.

17. The method of claim 1, further comprising:
in response to detecting the input corresponding to the first subject and in accordance with a determination that the first object is not with the first subject, outputting, via the one or more output devices, a fifth attribute of the computer system.

18. A non-transitory computer-readable storage medium storing one or more programs configured to be executed by one or more processors of a computer system that is in communication with one or more input devices and one or more output devices, the one or more programs including instructions for:
detecting, via the one or more input devices, an input corresponding to a first subject; and
in response to detecting the input corresponding to the first subject:
in accordance with a determination that a first object, different from the computer system, is with the first subject, outputting, via the one or more output devices, a first attribute of the first object; and
in accordance with a determination that the first object is not with the first subject, forgoing outputting, via the one or more output devices, the first attribute of the first object.

19. A computer system that is in communication with one or more input devices and one or more output devices, comprising:
one or more processors; and
memory storing one or more programs configured to be executed by the one or more processors, the one or more programs including instructions for:
detecting, via the one or more input devices, an input corresponding to a first subject; and
in response to detecting the input corresponding to the first subject:
in accordance with a determination that a first object, different from the computer system, is with the first subject, outputting, via the one or more output devices, a first attribute of the first object; and
in accordance with a determination that the first object is not with the first subject, forgoing outputting, via the one or more output devices, the first attribute of the first object.
